(19) United States
(12) Patent Application Publication
(10) Pub. No.: US 2026/0329989 A1
(43) Pub. Date: Oct. 22, 2026

(54) SYSTEMS AND METHODS FOR AUTOMATED AUTHORIZED DECISION-MAKING BASED ON VALUE-ALIGNED RECOMMENDATIONS

(71) Applicant: ANTHROPOGENIC INC., Boston, MA (US)

(72) Inventors: Ben ESGET, Bellingham, WA (US); Jason PETRALIA, Boston, MA (US)

(21) Appl. No.: 19/632,021

(22) Filed: Mar. 27, 2026

Related U.S. Application Data
(60) Provisional application No. 63/780,090, filed on Mar. 28, 2025.
(60) Provisional application No. 63/780,087, filed on Mar. 28, 2025.

(51) Int. Cl. G06F 21/31

(52) U.S. Cl. CPC G06F 21/31

(57) ABSTRACT

The present disclosure relates to a system and method for automated authorized decision-making. The method comprises processing a first dataset acquired from a first set of data sources, the first dataset comprising user preference data and non-user entity data. A value-aligned user profile is generated using a hybrid model to analyze the first dataset according to a predefined value framework. A user authorization is determined using a Large Language Model (LLM) to analyze a second dataset acquired from a second set of data sources comprising a decision-making prompt. A decision recommendation is generated interdependently based on the value-aligned user profile and the determined user authorization, wherein the recommendation comprises a quantitative score corresponding to alignment with the user preferences.

### INCORPORATION BY REFERENCE

This application claims priority to U.S. Provisional Application No. 63/780,087 filed on Mar. 28, 2025, and U.S. Provisional Application No. 63/780,090 filed on Mar. 28, 2025, each of which is hereby incorporated by reference in its entirety.

### TECHNICAL FIELD

The present disclosure relates to systems and methods for automated voting, and more particularly, to systems and methods for automating proxy voting processes to generate value-aligned voting decisions for shareholders.

### BACKGROUND

The “background” description provided herein is to generally present the context of the disclosure. Work of the presently named inventors, to the extent it is described in this background section, as well as aspects of the description which may not otherwise qualify as prior art at the time of filing, are neither expressly nor impliedly admitted as prior art against the present invention.

Proxy voting, in corporate governance, enables shareholders to express positions on matters such as board elections, executive compensation, and shareholder proposals. Within index funds and other passive investment vehicles, the voting authority is typically centralized among fund managers, with limited participation from beneficial owners of the underlying securities. As index funds now account for a substantial portion of total equity holdings, this concentration of proxy voting authority has raised widespread concerns regarding accountability, transparency, and alignment with investor values.

Traditional proxy voting systems are characterized by complex and voluminous materials, frequent procedural barriers, and an absence of personalization mechanisms. Most proxy statements comprise technical, legal, and financial terminology, often spanning hundreds of pages, thereby deterring participation from retail and institutional investors alike. The resulting apathy has led to billions of unvoted shares annually, representing a significant gap in shareholder influence over corporate decision-making.

Existing electronic proxy voting platforms are generally limited to facilitating vote submission workflows and distributing company-prepared materials. These platforms do not provide individualized decision support tools, nor do they offer predictive analytics to align voting outcomes with a shareholder's ethical, financial, or ideological principles. In consequence, shareholder decisions are often delegated to proxy advisors or defaulted to fund manager recommendations, creating a disconnect between the voting outcome and the underlying investor's intent.

Efforts to reform proxy voting procedures have focused primarily on increasing transparency and improving accessibility. While such efforts have improved certain operational efficiencies, they have not addressed the core limitation of value misalignment in mass voting environments. Current systems lack the capability to map complex investor preferences to multi-dimensional corporate governance decisions or to interpret the policy implications of shareholder proposals using data-driven models.

Artificial intelligence and machine learning technologies have recently emerged as potential tools for improving decision intelligence across various sectors, including financial services. In the context of proxy voting, these technologies offer a means to synthesize voluminous corporate data, analyze historical voting trends, and extract normative value signals from investor behavior. When integrated with secure data acquisition pipelines and dynamic user preference frameworks, these technologies may enable the automated generation of voting decisions that better reflect shareholder objectives.

Despite the availability of AI-based tools in adjacent domains such as portfolio management and sentiment analysis, existing proxy voting frameworks have yet to implement an end-to-end system that autonomously ingests proxy materials, generates voting recommendations based on personalized value frameworks, calculates voting power, and submits votes through authenticated APIs to proxy service providers. The absence of such a unified, AI-enabled proxy voting infrastructure continues to impede shareholder engagement, particularly in large-scale investment vehicles where manual decision-making is impractical.

When integrated into a graphical user interface, these technologies can enable data-driven recommendation generation, contextual visualization of proposals, and explainable AI (XAI) features that provide rationale behind vote suggestions. Such interfaces may present shareholders with interactive dashboards, real-time alignment indicators, and decision-support overlays that synthesize complex proxy materials into actionable insights, thereby reducing informational barriers and promoting informed participation.

Accordingly, there exists a need for systems and methods that integrate artificial intelligence, machine learning, and secure data infrastructures, and incorporate intelligent, interactive graphical user interfaces, to enable scalable, personalized, transparent, and legally compliant proxy voting automation. Such interfaces would enable investors to define and modify preference models, review AI-generated voting recommendations, visualize alignment with predefined value frameworks, and execute proxy votes autonomously across a distributed portfolio through seamless integration with voting platforms, thereby facilitating enhanced corporate oversight and restoring meaningful participation and influence to beneficial owners.

### SUMMARY

Described herein are methods for automated authorized decision-making. In some variations, a computer-implemented method for automated authorized decision-making may comprise processing a first dataset acquired from a first set of data sources, wherein the first dataset may comprise user preference data and non-user entity data. In some variations, the method may further comprise generating a value-aligned user profile using a hybrid model to analyze the first dataset according to a predefined value framework. In some variations, the method may further comprise determining a user authorization using a Large Language Model (LLM) to analyze a second dataset acquired from a second set of data sources comprising a decision-making prompt. In some variations, the method may further comprise generating a decision recommendation interdependently based on the value-aligned user profile and the determined user authorization, where the recommendation may comprise a quantitative score corresponding to alignment with the user preferences. In some variations, the method may further comprise executing a decision, via electronic integration with a platform, in accordance with the recommendation.

In some variations, the hybrid model may comprise one or more of rule-based decision trees, unsupervised learning models, few-shot classification models, or clustering models. In some variations, the method may further comprise recording a decision made by the user in response to the decision-making prompt and whether the decision recommendation was followed. In some variations, the method may further comprise updating the hybrid model based on the recorded decision and whether the decision recommendation was followed. In some variations, updating the hybrid model may comprise adjusting a quantitative weight of the hybrid model. In some variations, the method may further comprise updating the user preference data based on the recorded decision and whether the decision recommendation was followed. In some variations, the method may further comprise updating the value-aligned user profile based on the recorded decision and whether the decision recommendation was followed.

In some variations, the decision recommendation may be generated using a recommendation system. In some variations, the recommendation system may comprise a Large Language Model (LLM) and pre-trained transformer-based encoders with multi-head attention mechanisms. In some variations, the method may further comprise updating the recommendation system based on the recorded decision and whether the decision recommendation was followed. In some variations, updating the recommendation system may comprise adjusting a quantitative weight of the recommendation system.

In some variations, the method may further comprise recording decisions made by a cohort of users in response to respective decision-making prompts and whether corresponding decision recommendations were followed. In some variations, the method may further comprise updating the hybrid model based on aggregate trends identified across the recorded decisions of the cohort of users. In some variations, the method may further comprise updating a recommendation system used to generate the decision recommendation based on aggregated trends identified across the recorded decisions of the cohort of users.

In some variations, generating the value-aligned user profile may comprise categorizing the first dataset in accordance with the predefined value framework using the hybrid model. In some variations, the first set of data sources may comprise public records, social media, news coverage, supply chain data, sensor data, or patterns observable in any of the foregoing. In some variations, the second set of data sources may comprise web data, public records, third-party data providers, data repositories, or news coverage. In some variations, the method may further comprise assigning and normalizing quantitative weights to the first dataset based on relative relevance to the user preferences. In some variations, the user preference data may be received during an onboarding process. In some variations, the method may further comprise the user modifying the user preferences at the onboarding process.

In some variations, generating the decision recommendation may comprise determining true impact of a decision by applying causal inference techniques and performing counterfactual analysis to assess alternative outcomes of the decision, and forecasting impacts of the decision by performing predictive analytics using a recommendation system, wherein the recommendation system may comprise regulations, best practices, and technological data. In some variations, generating the decision recommendation may further comprise setting a user-defined confidence threshold that prompts a manual review when the threshold is unmet. In some variations, the method may further comprise continuously updating the value-aligned user profile based on a real-time data processing system comprising an event-based triggering subsystem, a new data analysis subsystem, and a scheduled re-analysis subsystem.

In some variations, the method may further comprise generating an explanation via an explainable AI (XAI) interface to provide rationales behind the decision recommendation. In some variations, the method may further comprise dynamically adjusting the decision recommendation score based on real-time external data inputs relevant to the predefined value framework. In some variations, geographic data may be incorporated to dynamically adjust the decision recommendation based on regional differences in environmental or regulatory conditions. In some variations, the method may further comprise dynamically adjusting a weight of the predefined value framework based on user-defined rules responsive to external market or conditions and sentiment analysis of real-time news and social media data. In some variations, the method may further comprise applying personalized ethical constraints that override the decision recommendation under user-specified criteria, wherein the value-aligned user profile may integrate established personal values assessments.

For example, a method of automating decision-making may comprise processing a first dataset corresponding to proxy voting, wherein the first dataset may be acquired from a first set of data sources and may include data related to voting preferences of a voter and data related to entities. In some variations, the method may further comprise generating a value-aligned voter profile by using an Artificial Intelligence (AI) system to analyze and categorize the first dataset in accordance with a predefined value framework. In some variations, the method may further comprise determining proxy voting rights for the voter by analyzing, using a Large Language Model (LLM), a second dataset corresponding to a proxy statement retrieved from a second set of data sources. In some variations, the method may further comprise generating a proxy voting recommendation interdependently based on the value-aligned voter profile and the determined proxy voting rights, wherein the proxy voting recommendation may be quantitatively scored in alignment with voting preferences of the voter. In some variations, the method may further comprise executing a proxy vote, via electronic integration with at least one proxy voting platform, in accordance with the proxy voting recommendation.

Also described herein are systems for automated authorized decision-making. In some variations, a system for automated authorized decision-making may comprise a data processing subsystem configured to process a first dataset acquired from a first set of data sources, wherein the first dataset may comprise user preference data and non-user entity data. In some variations, the system may further comprise a user profile generation subsystem configured to generate a value-aligned user profile using a hybrid model to analyze the first dataset according to a predefined value framework. In some variations, the system may further comprise an authorization determination subsystem configured to determine a user authorization using a Large Language Model (LLM) to analyze a second dataset acquired from a second set of data sources comprising a decision-making prompt. In some variations, the system may further comprise a recommendation engine configured to generate a decision recommendation interdependently based on the value-aligned user profile and the determined user authorization, wherein the recommendation may comprise a quantitative score corresponding to alignment with the user preferences. In some variations, the system may further comprise an automated decision execution subsystem configured to execute a decision, via electronic integration with a platform, in accordance with the decision recommendation.

Also described herein are non-transitory computer-readable media for automated authorized decision-making. In some variations, a non-transitory computer-readable medium storing instructions that, when executed by one or more processors, may cause the processors to perform operations may be provided. In some variations, the operations may comprise processing a first dataset acquired from a first set of data sources, wherein the first dataset may comprise user preference data and non-user entity data. In some variations, the operations may further comprise generating a value-aligned user profile using a hybrid model to analyze the first dataset according to a predefined value framework. In some variations, the operations may further comprise determining a user authorization using a Large Language Model (LLM) to analyze a second dataset acquired from a second set of data sources comprising a decision-making prompt. In some variations, the operations may further comprise generating a decision recommendation interdependently based on the value-aligned user profile and the determined user authorization, wherein the recommendation may comprise a quantitative score corresponding to alignment with the user preferences. In some variations, the operations may further comprise executing a decision, via electronic integration with a platform, in accordance with the decision recommendation.

Also described herein are systems for automated authorized decision-making comprising a graphical user interface. In some variations, a system for automated authorized decision-making may comprise one or more processors, a memory accessible by the processors, and a display operably coupled to the one or more processors. In some variations, the system may be configured to display, via the display, a graphical user interface (GUI) comprising graphical elements configured to receive user input related to user preferences. In some variations, the system may be further configured to electronically process a first dataset acquired from a first set of data sources, wherein the first dataset may comprise user preference data and non-user entity data. In some variations, the system may be further configured to generate a value-aligned user profile using a hybrid model to analyze the first dataset according to a predefined value framework. In some variations, the system may be further configured to retrieve a second dataset from a second set of data sources comprising a decision-making prompt and to analyze the second dataset using a Large Language Model (LLM) to determine a user authorization. In some variations, the system may be further configured to generate a decision recommendation interdependently based on the value-aligned user profile and the determined user authorization, wherein the recommendation may comprise a quantitative score corresponding to alignment with the user preferences. In some variations, the system may be further configured to display, through the GUI on the display, the decision recommendation and to enable user interaction with the GUI to review or modify the recommendation prior to automatically executing a decision via a platform.

For example, a system for automating decision-making may comprise a data processing subsystem configured to process a first dataset corresponding to proxy voting, wherein the first dataset may be acquired from a first set of data sources and may correspond to data related to voting preferences of a voter and data related to entities. In some variations, the system may further comprise a voter profile generation subsystem configured to generate a value-aligned voter profile by using an Artificial Intelligence (AI) system to analyze and categorize the first dataset in accordance with a predefined value framework. In some variations, the system may further comprise a proxy rights determination subsystem configured to determine proxy voting rights for the voter by analyzing, using a Large Language Model (LLM), a second dataset corresponding to a proxy statement retrieved from a second set of data sources. In some variations, the system may further comprise a recommendation engine configured to generate a proxy voting recommendation interdependently based on the value-aligned voter profile and the determined proxy voting rights, wherein the proxy voting recommendation may be quantitatively scored in alignment with voting preferences of the voter. In some variations, the system may further comprise an automated voting execution subsystem configured to execute a proxy vote, via electronic integration with at least one proxy voting platform, in accordance with the proxy voting recommendation.

In some variations, processing the first dataset may comprise analyzing user interactions and content from social media platforms using natural language processing (NLP), processing transcripts or recordings from user-associated media appearances using NLP techniques, analyzing historical patterns obtained from records and services, performing AI-driven aggregation and analysis of news articles relevant to user-defined values, and identifying user political affiliations through publicly available records and campaign contribution data. In some variations, the GUI may further comprise at least one graphical object configured to display dynamically updated user profile attributes categorized according to the predefined value framework, wherein the user profile attributes may be generated using machine learning categorization techniques. In some variations, the GUI may comprise at least one graphical object configured to display quantitative weights assigned to the first dataset, wherein the weights may be dynamically normalized based on relative relevance to user preferences, and wherein the GUI may further enable users to modify preferences initially captured during an onboarding process. In some variations, analyzing the first dataset may further comprise determining true impact of a decision by applying causal inference techniques, performing counterfactual analysis to assess alternative outcomes of the decision, and forecasting impacts of the decision by performing predictive analytics using a recommendation system, wherein the recommendation system may comprise regulations, best practices, and technological data.

In some variations, the GUI may comprise at least one graphical object configured to display decision recommendations, and the GUI may further enable setting user-defined confidence thresholds prompting manual review of recommendations when thresholds are unmet, wherein the recommendations may be generated using supervised machine learning trained on historical outcomes. In some variations, the GUI may comprise at least one graphical object configured to provide explanatory feedback generated by an Explainable AI (XAI) subsystem, thereby enabling users to access transparent rationales behind decision recommendations. In some variations, the GUI may comprise graphical objects configured to dynamically display adjusted decision recommendation scores based on real-time external data inputs relevant to the predefined value framework, and geographic data may be visually incorporated to dynamically adjust the recommendations according to regional environmental or regulatory conditions.

In some variations, the GUI may comprise graphical objects configured to display dynamically adjusted weighting of the predefined value framework based on user-defined rules responsive to external market conditions or real-time sentiment analysis of news and social media data. In some variations, the GUI may further comprise graphical elements configured for applying personalized ethical constraints defined by the user, wherein the personalized ethical constraints may override the decision recommendations under specified criteria, and wherein the user profile may integrate established personal values assessments. In some variations, the GUI may further comprise graphical elements enabling users to manage and continuously update the user profile based on real-time ingestion and analysis of newly acquired data from the first set of data sources. In some variations, the GUI may further comprise an interface subsystem configured for displaying detailed information related to identified entities, initiatives, and user authorization, and the GUI may enable user interaction to explore multiple scenarios and counterfactual analyses related to decision recommendations.

Also described herein are methods for automated authorized decision-making via a graphical user interface. In some variations, a method for automated authorized decision-making via a graphical user interface (GUI) may comprise displaying, via a display, the GUI comprising graphical elements configured to receive user input related to user preferences. In some variations, the method may further comprise processing a first dataset, wherein the first dataset may comprise user preference data and non-user entity data. In some variations, the method may further comprise generating a value-aligned user profile by analyzing the first dataset using a hybrid model according to a predefined value framework.

In some variations, the method may further comprise retrieving and analyzing decision-making prompt data using an LLM to determine a user authorization. In some variations, the method may further comprise generating decision recommendations interdependently based on the user profile and determined user authorization, wherein the recommendations may comprise a quantitative score corresponding to alignment with user preferences. In some variations, the method may further comprise displaying decision recommendations through the GUI. In some variations, the method may further comprise electronically executing decisions via integration with a platform in accordance with the displayed recommendations.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a system architecture for an automated proxy voting system, according to certain embodiments.

FIG. 1B illustrates an exemplary system architecture for implementing the automated proxy voting system within a distributed computing environment, according to certain a

FIG. 2 is a block diagram of the automated proxy voting system, according to certain embodiments.

FIG. 3 illustrates an exemplary workflow for value-aligned proxy voting across different investor accounts and fund structures, according to certain embodiments.

FIG. 4 illustrates a flowchart depicting a method for generating proxy voting decisions, according to certain embodiments.

FIG. 5 shows an example computer system that can be used to implement the technology disclosed, according to certain embodiments.

FIG. 6 is a schematic representation of an encoder-decoder architecture.

FIG. 7 shows an overview of an attention mechanism added onto an RNN encoder-decoder architecture.

FIG. 8 is a schematic representation of the calculation of self-attention showing one attention head.

FIG. 9 is a depiction of several attention heads in a Transformer block.

FIG. 10 is an illustration that shows how one can use multiple workers to compute the multi-head attention in parallel, as the respective heads compute their outputs independently of one another.

FIG. 11 is a portrayal of one encoder layer of a Transformer network.

FIG. 12 shows a schematic overview of a Transformer model.

FIG. 13 is a depiction of a Vision Transformer (ViT).

FIG. 14 illustrates a processing flow of the Vision Transformer (ViT).

FIG. 15 shows example software code that implements a Transformer block.

FIG. 16 illustrates an exemplary graphical user interface (GUI) workflow architecture for the automated proxy voting system, according to certain embodiments.

FIG. 17 illustrates a flowchart depicting an exemplary method for automatically generating and executing proxy votes in alignment with a predefined voter value framework, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. Furthermore, the terms “approximately,” “approximate,” “about,” and similar terms generally refer to ranges that include the identified value within a margin of 20%, 10%, or preferably 5%, and any values therebetween.

Aspects of the present disclosure relate to a computer-implemented methods, systems, and non-transitory computer-readable mediums for automated authorized decision-making (e.g., proxy voting), utilizing artificial intelligence-based analysis of user preferences (e.g., shareholder voting preferences) and decision-making prompt materials (e.g., proxy statements and proxy-related disclosures). The system may receive a first dataset from a first set of data sources (e.g., proxy-related data from regulatory filings, financial disclosures, third-party data feeds, and/or user input). The system may construct a value-aligned user profile (e.g., a voter profile) using a hybrid model configured to analyze and/or classify input data according to a predefined value framework. For instance, the hybrid model may comprise one or more of rule-based decision trees, unsupervised learning models, few-shot classification models, or clustering models, as will be described in more detail herein. A large language model (LLM) may evaluate a second dataset acquired from a second set of data sources comprising a decision-making prompt (e.g., proxy statements, meeting notices, and shareholder proposals) to determine applicable user authorization (e.g., voting rights and voting power) and predict alignment of various decision options with user-defined criteria (e.g., stakeholder-defined environmental, social, and governance preferences). Based on the generated value-aligned user profile and the analyzed content, a decision recommendation (e.g., a voting recommendation) may be generated. To improve transparency and accuracy, the recommendation may include a quantitative score corresponding to alignment with the user preferences. The recommendation may be submitted through secure electronic integration with one or more platforms (e.g., proxy voting platforms such as Broadridge, ISS ProxyExchange, or Equiniti).

The system may apply data retrieval pipelines to collect and standardize a first dataset from a first set of data sources. The first set of data sources may including regulatory filings, financial disclosures, social commentary, public records, historical voting behavior (e.g., of the user, of an aggregate of the users), public records, social media, news coverage, supply chain data, sensor data, and the like, and/or patterns observable in any of the foregoing. One or more machine learning models may transform unstructured information into structured data points consistent with value-based scoring methodologies. The first dataset may comprise user preference data (e.g., investor voting histories and preference signals) and non-user entity data (e.g., corporate governance metrics and issuer disclosures). Value-aligned user profiles (e.g., voter profiles) may be adjusted over time in response to updated preference signals and shifts in corporate governance or macroeconomic environments. For example, a value-aligned user profile may be adjusted based on a decision (e.g., vote) made by the user and whether that vote aligned with a decision recommendation.

Decision recommendations (e.g., voting recommendations) may be computed using a recommendation system comprising supervised learning algorithms refined by probabilistic reasoning, causal modeling, and/or prediction confidence scoring. In some embodiments, generating the decision recommendation may comprise determining true impact of a decision by applying causal inference techniques and performing counterfactual analysis to assess alternative outcomes of the decision, and forecasting impacts of the decision by performing predictive analytics using the recommendation system, wherein the recommendation system may comprise regulations, best practices, and technological data. A user-defined confidence threshold may prompt a manual review when the threshold is unmet, thereby permitting optional human review prior to submission when a recommendation confidence level is below a defined limit. The system may further support generating an explanation via an explainable AI (XAI) interface to provide rationales behind the decision recommendation, thereby enhancing transparency and user trust.

Thereby, through the integration of AI-enabled profiling using the hybrid model, large-scale data analysis, and secure execution, the system may address inefficiencies in traditional decision-making workflows (e.g., proxy voting workflows) and may provide a personalized and scalable method for automated authorized decision-making (e.g., automated shareholder decision-making). The system may execute a decision, via electronic integration with a platform (e.g., a proxy voting platform), in accordance with the decision recommendation. Importantly, the hybrid model and the recommendation system may be continuously refined through adaptive feedback mechanisms, whereby recorded user decisions and indications of whether decision recommendations were followed may be used to adjust quantitative weights within the hybrid model and the recommendation system, thereby progressively improving the accuracy and relevance of future decision recommendations. Additionally, the value-aligned user profile and underlying user preference data may be updated in response to such recorded decisions, enabling the system to learn from individual user behavior over successive decision cycles. Cohort-level feedback aggregation may further enhance model performance by identifying emergent trends across a plurality of users, allowing the system to incorporate collective behavioral signals into its predictive models.

As a result, the system may achieve superior alignment between decision outcomes and user-defined values compared to traditional human-driven decision-making processes, which are often constrained by cognitive limitations, information asymmetry, and the impracticability of manually analyzing voluminous, complex, and/or real-time data at scale. By systematically processing and synthesizing large volumes of structured and unstructured data against a predefined value framework, the system may reduce inconsistencies, mitigate subjective bias, and ensure that each decision recommendation reflects a comprehensive, data-driven assessment of alignment with the user's expressed preferences. Furthermore, the scalability of the automated system may enable consistent, value-aligned decision-making across large and diversified portfolios, a capability that is impractical to achieve through manual processes alone, thereby restoring meaningful participation and influence to beneficial owners who would otherwise be unable to exercise informed decision-making authority at scale.

### High-Level System Architecture

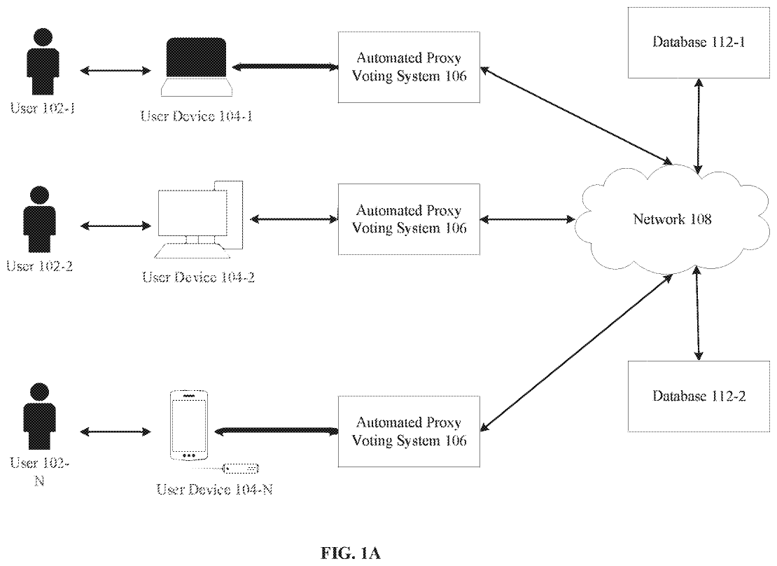

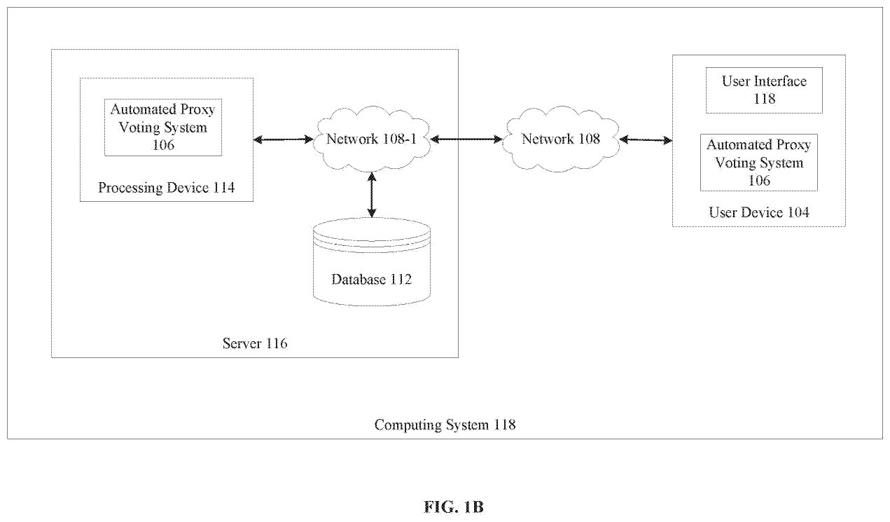

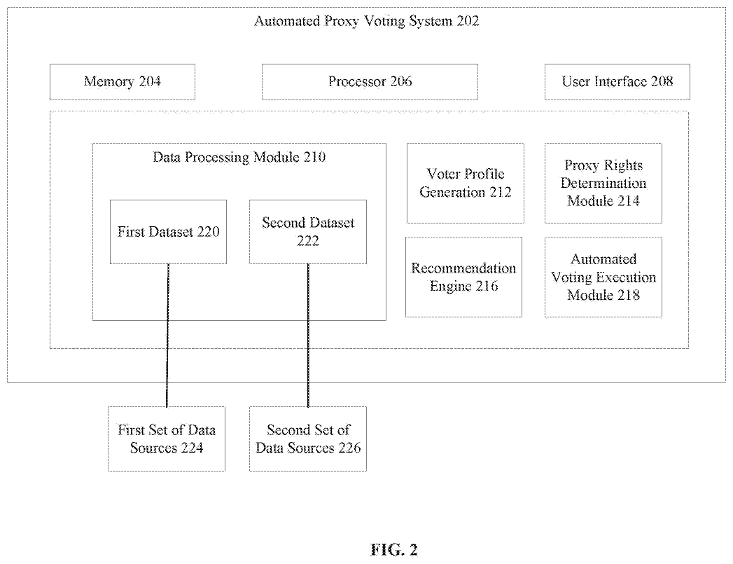

FIG. 1A illustrates a system architecture 100 of an automated authorized decision-making system (e.g., an automated proxy voting system) configured to interface with multiple user devices and process data from structured and unstructured sources to generate predictive decision recommendations (e.g., proxy voting recommendations). The system architecture 100 may include a plurality of users 102-1 through 102-N operating respective user devices 104-1 through 104-N that are communicatively connected to an automated proxy voting system 106 via a network 108.

The plurality of users 102-1 through 102-N, combinedly referred to as users 102, may include individual shareholders, institutional investors, asset managers, proxy advisors, data analysts, or corporate stakeholders. Each user 102 may access the automated proxy voting system 106 via a respective user device 104, which may include, without limitation, desktop computers, laptops, mobile phones, tablets, wearable computing devices, or any computing platform capable of supporting web-based or application-based interfaces. The user devices 104 may be configured to transmit voting preferences, receive predictive recommendations, review historical proxy records, and initiate or authorize vote execution actions.

Each user device 104 communicates with an automated proxy voting system 106 over the network 108. The network 108 connecting the user devices 104 with the automated proxy voting system 106 may be implemented as a single or multiple interconnected networks. The network 108 may include, but is not limited to, a local area network (LAN), wide area network (WAN), metropolitan area network (MAN), personal area network (PAN), body area network (BAN), or combinations thereof. The network 108 may support wired links including Ethernet, fiber-optic, coaxial, and DSL, as well as wireless links including Wi-Fi, Bluetooth, WiMAX, infrared, and cellular communication standards such as 3G, 4G, 5G, LTE, or satellite-based links. Communication protocols supported over the network may include TCP/IP, UDP, ATM, SONET, SDH, and related telecommunications standards.

The automated proxy voting system 106, alternatively referred to as a system 106, is configured to receive input data from the user devices 104, retrieve external datasets from a plurality of structured and unstructured data sources, and generate decision recommendations (e.g., proxy voting recommendations) that are aligned with predefined or inferred user preferences. The system 106 may be implemented on one or more computing platforms and may include machine learning models, semantic reasoning engines, and rule-based logic subsystems for data interpretation and decision recommendation generation.

In one embodiment, the automated proxy voting system 106 accesses a structured data source 112-1, which may include regulatory repositories such as the SEC's EDGAR system, issuer filings (e.g., DEF 14A), meeting notices, proxy statements, financial disclosures, and standardized datasets from platforms such as ISS and Broadridge. This structured data may support factual analysis of corporate proposals, board nominations, and governance matters.

In addition, the system 106 may interface with an unstructured data source 112-2 comprising real-time and historical data streams including financial news, social media sentiment, public podcasts, press releases, ESG alerts, and advocacy materials. These unstructured datasets may be processed using artificial intelligence techniques such as natural language processing (NLP), named entity recognition (NER), sentiment scoring, and topic modeling to infer qualitative dimensions relevant to proposals, candidates, or issuers.

The automated proxy voting system 106 may include one or more Artificial Intelligence subsystems implementing a hybrid model that may function as intelligent intermediaries between user-defined value frameworks and incoming agenda data. The hybrid model may comprise one or more of rule-based decision trees, unsupervised learning models, few-shot classification models, or clustering models. In certain embodiments, the system 106 may maintain a semantic model that encodes relationships among proposal categories, environmental and governance factors, candidate profiles, and investor typologies. The semantic model may be monolithic or modular and may include language-specific or language-agnostic components. The semantic model thus may support mapping between generalized user intentions (e.g., “pro-environment”) and the specific characteristics of agenda items requiring a vote.

The system 106 may operate as an omni-channel, proactive virtual agent capable of bidirectional communication with the user devices 104. Communication modes may include email notifications, push alerts, voice commands, natural language chat interfaces, and interactive dashboards. The system 106 may respond to queries regarding upcoming ballots, provide voting recommendations, summarize prior votes, and suggest profile updates based on evolving issue landscapes. For instance, a manager may receive a data-driven alert highlighting a vote misalignment with their historical ESG stance, or a retail investor may be prompted to refine their profile to account for newly emerging governance metrics.

Further, the automated proxy voting system 106 may implement profile management workflows, where a value-aligned user profile (e.g., value-aligned preference vectors) may be built using explicit user inputs, inferred historical voting behavior, behavioral clustering, and feedback loops. These profiles may guide real-time recommendation generation. The system may be configured for adaptive recalibration, allowing profiles to evolve over time based on user corrections, engagement behavior, or updated strategic objectives.

In certain enterprise settings, users 102 may include data analysts or compliance officers leveraging the automated proxy voting system 106 to extract insights from aggregated voting data, conduct pattern analysis, and generate reports for governance oversight. For instance, a data analyst may initiate queries to examine divergence between stated values and executed votes across a portfolio of companies or generate predictive models for future shareholder behavior.

Recommendations generated by the automated proxy voting system 106 may be transmitted to the respective user devices 104 for user review, confirmation, or automated submission. In some implementations, the system 106 is configured to connect with downstream proxy execution platforms via secure APIs, thereby allowing direct instruction submission and status tracking.

FIG. 1B illustrates an exemplary system architecture 100B for implementing the automated proxy voting system 106 within a distributed computing environment. The system architecture 100B may comprise a computing system 118 that hosts the system 106, a user device 104 that interfaces with end users, a processing device 114 that performs computational tasks, and a database 112 that provides persistent data storage.

The computing system 118 may serve as the central processing hub for the system 106 and may be realized as a virtual machine, cloud-based infrastructure, edge computing device, or an on-premise server cluster. The system 106 may reside entirely on the computing system 118 or may be distributed across both the computing system 118 and the user device 104. This allows for deployment flexibility and supports edge-based inference execution or decision visualization directly on user endpoints.

The system 106 may comprise multiple functional subsystems configured to manage the end-to-end workflow of proxy voting. These subsystems may include data ingestion pipelines, machine learning inference engines, voting rights analyzers, recommendation engines, and electronic vote execution logic. The system may be designed to align shareholder votes with user-defined value frameworks by analyzing real-time proxy statements, historical behavior, and investor preferences.

The processing device 114 may be configured to execute high-performance computational workloads associated with the system 106. The processing device 114 may include central processing units (CPUs) for general-purpose computing, graphics processing units (GPUs) and tensor processing units (TPUs) for machine learning inference, and field-programmable gate arrays (FPGAs) for low-latency processing. These processing elements may be responsible for tasks such as parsing agenda items, running large language models (LLMs), computing alignment scores, and applying eligibility logic.

The database 112 may be connected to both the processing device 114 and the computing system 118 over the second network 108-1. The database 112 may store a wide range of structured and unstructured data elements, including user-defined voting frameworks (e.g., ESG, SASB, or Scope 1-3 emissions), parsed proxy materials, prior voting records, alignment logs, audit trails, and execution receipts. The database 112 may utilize SQL or NoSQL technologies and support encryption-at-rest, multi-zone replication, and scalable indexing.

The user device 104 may be connected to the computing system 118 via the first network 108 and may serve as the primary interface for users to interact with the system 106. The user device 104 may be implemented as a desktop terminal, tablet, smartphone, or web client. It may provide access to a user interface 208, through which investors may configure value preferences, review recommendations, approve or override suggested votes, and monitor the status of submitted instructions.

During operation, proxy agenda data may be received from upstream sources via the second network 108-1 and processed by the system 106 hosted on the computing system 118. The processing device 114 may parse this data, evaluate voting eligibility by analyzing investor holdings, and invoke LLM-based inference to generate vote recommendations that are aligned with the investor's configured framework. The recommendations, along with associated rationales and confidence scores, may be transmitted to the user device 104 for review.

Following approval or user-defined adjustments, the system 106 may generate structured vote instructions and may submit them to downstream proxy execution platforms. Acknowledgment receipts and execution confirmations may be stored in the database 112 and made available through the user interface 208 on the user device 104. The system may also support bi-directional communication, enabling users to modify preferences, query rationale summaries, or provide feedback through natural language interfaces.

The networks 108 and 108-1 may enable robust connectivity across all components. The first network 108 may include Internet-based protocols, such as TCP/IP and HTTP/2, and support wired connections (e.g., Ethernet, DSL, fiber-optic) and wireless links (e.g., Wi-Fi, Bluetooth, 3G/4G/5G). The second network 108-1 may serve as a dedicated internal communication channel, optimized for low-latency and secure data flow between core processing components. The dual-network design enhances modularity and security across the architecture.

Collectively, FIG. 1B depicts a comprehensive, modular system for executing automated, value-aligned proxy voting decisions through an intelligent and scalable computing infrastructure. The interconnections between components allow seamless workflow execution, from data ingestion to user interaction and final vote submission.

### System Components and Functionality

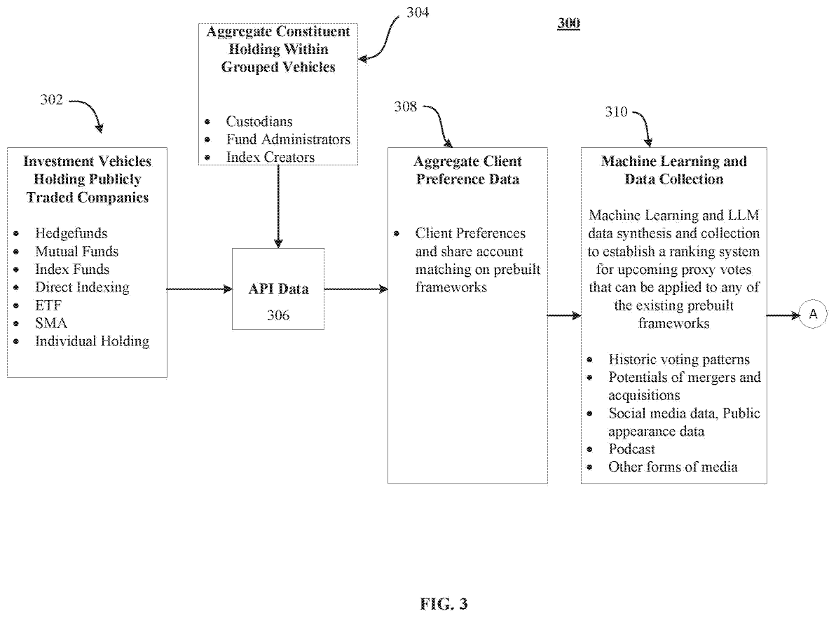

FIG. 2 illustrates an automated decision-making system (e.g., an automated proxy voting system 202) comprising an integrated architecture for generating, aligning, and, optionally, executing decision recommendations (e.g., proxy voting decisions) based on predefined user value frameworks (e.g., investor value frameworks), in accordance with certain embodiments of the present disclosure.

The system 202 may include a memory 204, a processor 206, and a user interface 208. The memory 204 may comprise volatile or non-volatile memory units, including DRAM, SRAM, flash memory, EEPROM, or persistent memory devices such as solid-state drives (SSD) or hard-disk drives (HDD). The memory 204 may be configured to store executable instructions, machine learning models, value alignment taxonomies, voting history, and user-defined value preferences including, but not limited to, environmental, social, and governance (ESG) parameters, Sustainability Accounting Standards Board (SASB) metrics, and Scope 1, Scope 2, and Scope 3 carbon emission benchmarks. In certain configurations, the memory 204 may be integrated with distributed NoSQL databases and cloud-hosted storage platforms to support horizontal scalability and secure remote access.

The processor 206 may be communicatively coupled to the memory 204 and may be operable to execute all computational and decision-making tasks. The processor 206 may include central processing units (CPUs), graphics processing units (GPUs), tensor processing units (TPUs), digital signal processors (DSPs), field-programmable gate arrays (FPGAs), application-specific integrated circuits (ASICs), or system-on-chip (SoC) implementations. In some embodiments, specialized AI accelerators may be employed to optimize inference computations associated with transformer-based language models or graph-based recommendation engines. The processor 206 may coordinate the operation of each subsystem by processing input data, invoking models, and managing inter-subsystem communication flows.

The user interface 208 may enable interaction between the user and the automated proxy voting system 202. The user interface 208 may be rendered as a graphical user interface (GUI), command-line interface (CLI), voice interface, or API endpoint accessible via user devices such as desktops, mobile phones, or tablets. The user interface 208 may support configuration of value preferences, policy overrides, real-time vote previews, post-vote confirmations, and visualization of audit trails, thereby enabling user supervision and control throughout the voting lifecycle.

The data processing subsystem 210 may be configured to receive, normalize, and parse a first dataset comprising user preference data and non-user entity data (e.g., proxy-related and contextual data) from a first set of data sources 224 and a second set of data sources 226. The data processing subsystem 210 may play a foundational role in the automated proxy voting system 202 by providing the factual, regulatory, environmental, and sentiment-rich context required for downstream alignment and decision recommendation generation (e.g., vote prediction). The objective of the data processing subsystem 210 may be to convert unstructured and semi-structured documents into structured, queryable formats optimized for alignment with user-defined value frameworks (e.g., investor-defined value frameworks) and for input into language model pipelines as part of the hybrid model.

In various embodiments, the data processing subsystem 210 may ingest proxy data using API-based integrations, RSS feeds, and custom web crawlers from regulatory sources such as the U.S. Securities and Exchange Commission (SEC)'s EDGAR system, DEF 14A filings, Schedule 14N filings, annual proxy statements, meeting notices, and Form 8-K events. The data processing subsystem 210 may further extract relevant fields using natural language processing (NLP) techniques such as named entity recognition (NER), relationship extraction, topic modeling, and sentence classification. This may include parsing vote agenda items, board member biographies, prior voting recommendations by advisory firms, and shareholder proposal justifications.

The data processing subsystem 210 may also ingest content from publicly disclosed investor relations websites of issuers, press releases, earnings call transcripts, and management letters. Third-party feeds integrated via APIs may include Institutional Shareholder Services (ISS), Glass Lewis, Broadridge, Morningstar, Equilar, and MSCI. In alternative embodiments, the system may include backup data scraping mechanisms to retrieve content in cases of feed failure. Document ingestion may support a range of formats including HTML, PDF, XBRL, and JSON.

The data processing subsystem 210 may be additionally configured to interface with news aggregation tools and social media APIs (e.g., Twitter, Reddit, Linkedin) to derive event-driven sentiment signals related to environmental, social, and governance (ESG) topics. For instance, the system may scrape sentiment shifts in response to an oil spill or executive misconduct, incorporating those signals into agenda-level sentiment variables. In one implementation, this sentiment stream is continuously fed into a temporal sentiment transformer model to enable real-time contextual updates to vote recommendations.

The data processing subsystem 210 may process multiple classes of data and store them in a structured format compliant with the schema required by downstream large language model (LLM) engines and recommendation engines. A first dataset 220 accessed by the data processing subsystem 210 may comprise user preference data, including investor voting histories, annotated corrections, behavioral overrides, and user feedback logs collected over time. This dataset may support adjusting (e.g., supervised fine-tuning) of the predictive voting engine and/or benchmarking of alignment fidelity.

A second dataset 222 may comprise non-user entity data, including environmental, social, and governance (ESG) metrics, emissions disclosures, and public accountability indicators. Specific components of this dataset may include CDP carbon intensity metrics (Scope 1, 2, and 3 emissions), MSCI ESG scores, Refinitiv governance scores, ISS QuickScore data, Equilar board diversity data, and Sustainalytics risk assessments. This dataset may also include real-time scraped content from news and social platforms, enriched by contextual embeddings for cross-domain integration. These ESG signals may be normalized and correlated with corporate identifiers using knowledge graph mapping techniques.

The data processing subsystem 210 may also access data from the second set of data sources 226, which may comprise web data, public records, third-party data providers, data repositories, or news coverage. Examples of such sources may include nonprofit sustainability networks, whistleblower platforms, corporate watch groups, and AI-driven public disclosure aggregators, such as CDP for Scope 3 supply chain emissions, Equilar for executive diversity metrics, Glassdoor for employee reviews, and Open Corporates for subsidiary ownership analysis.

Further, the data processing subsystem 210 may integrate investor-side data by capturing user onboarding preferences, value framework selections, political affiliation indicators, and sentiment-extracted social media interactions to support comprehensive profile calibration. The user preference data may be received during an onboarding process, and the user may modify the user preferences at the onboarding process. This may include analyzing user interactions and content from social media platforms using natural language processing (NLP), processing transcripts or recordings from user-associated media appearances using NLP techniques, analyzing historical patterns obtained from records and services, performing AI-driven aggregation and analysis of news articles relevant to user-defined values, and identifying user political affiliations through publicly available records and campaign contribution data.

The voter profile generation subsystem 212 (i.e., a user profile generation subsystem) may be configured to construct a value-aligned user profile (e.g., a value-aligned voting profile) using a hybrid model to analyze a combination of user-defined parameters, historical voting behavior, inferred investor objectives, and evolving regulatory guidance according to a predefined value framework. The objective of the voter profile generation subsystem 212 may be to synthesize a comprehensive representation of a shareholder's voting intent, enabling alignment of future proxy decisions with personalized, ideologically consistent frameworks.

The voter profile generation subsystem 212 may utilize a hybrid model comprising a hybrid computational architecture combining rule-based decision trees, unsupervised learning models, few-shot classification frameworks, and AI-based inference engines. At the initiation stage, the voter profile generation subsystem 212 may receive explicit input from an investor via the user interface 208. The input may include weighted selections across multiple predefined value categories, such as “pro-environmental,” “labor-aligned,” “anti-carbon,” “fossil-free,” or “religiously guided stewardship.” Users may further refine these selections using sliders, toggles, and keyword mappings to customize the intensity and priority of each factor. The system may assign and normalize quantitative weights to the first dataset based on relative relevance to the user preferences.

In some embodiments, the voter profile generation subsystem 212 may generate the value-aligned user profile by categorizing the first dataset in accordance with the predefined value framework using the hybrid model. The predefined value framework may comprise a hierarchical taxonomy of value categories, subcategories, and associated scoring dimensions against which user preference data and non-user entity data may be systematically organized and evaluated. For example, the predefined value framework may define top-level value domains such as environmental stewardship, social responsibility, corporate governance, financial performance, and ethical alignment, each of which may be further decomposed into granular subcategories. For example, an environmental stewardship domain may comprise subcategories corresponding to carbon emissions reduction, biodiversity preservation, water resource management, and circular economy practices. As yet another example, a corporate governance domain may comprise subcategories corresponding to board independence, executive compensation alignment, anti-corruption policies, and/or shareholder rights protections.

The predefined value framework may further define relational mappings between these categories and specific data attributes within the first dataset, such that each data point ingested from the first set of data sources may be classified into one or more categories of the framework. The hybrid model may apply rule-based decision trees to assign categorical labels to structured data elements, unsupervised learning models to identify latent thematic clusters within unstructured data, and few-shot classification models to categorize novel or previously unencountered data points by reference to learned structural similarities within the framework. Upon categorization, the system may assign and normalize quantitative weights to the categorized data based on relative relevance to the user preferences, thereby producing a multi-dimensional, weighted representation of the user's value alignment across the full taxonomy of the predefined value framework. This structured categorization may enable the recommendation engine 216 to perform granular, category-level alignment scoring between the user's weighted value profile and individual decision-making prompts, rather than relying on aggregate or undifferentiated preference signals.

In some embodiments, the voter profile generation subsystem 212 may access historical proxy vote records stored in the first dataset 220, which may include timestamped user decisions, rationale overrides, correction logs, and annotated feedback. The subsystem may apply behavioral clustering algorithms to detect latent preferences not explicitly stated by the user, and may integrate probabilistic matching models to map historic behavior to present decision contexts.

To address novel or previously unencountered proposals, such as first-time disclosures of Scope 3 emissions transition plans, the voter profile generation subsystem 212 may apply few-shot classification using a pretrained LLM to identify structural similarity between the new proposal and historical examples. For instance, if a shareholder previously supported deforestation risk disclosures, and a new resolution calls for land-use transparency in the supply chain, the subsystem may infer an aligned “yes” vote unless contradicted by updated preference vectors.

In one implementation, the voter profile generation subsystem 212 may reference public regulatory guidance, stewardship codes (e.g., UK Stewardship Code, OECD Guidelines), and industry standards such as SASB, to calibrate profiles for institutional clients. This may be particularly applicable for ESG-aligned funds where compliance with stewardship obligations is programmatically embedded into the voter logic.

The voter profile generation subsystem 212 may continuously update the value-aligned user profile using a closed-loop feedback system. Upon execution of votes via the automated voting execution subsystem 218, the system may record a decision made by the user in response to the decision-making prompt and whether the decision recommendation was followed. User overrides, confirmations, or edits may be logged back into the system memory 204 and reprocessed by the voter profile generation subsystem 212 to recalibrate weightings. In some embodiments, updating the hybrid model may comprise adjusting a quantitative weight of the hybrid model. The system may further update the user preference data and the value-aligned user profile based on the recorded decision and whether the decision recommendation was followed. This may enable adaptive learning where the system evolves based on observed investor behavior over multiple voting cycles.

In certain embodiments, the voter profile generation subsystem 212 may be further configured to continuously update the value-aligned user profile based on a real-time data processing system comprising a plurality of mechanisms, thereby ensuring that the profile remains contextually relevant and reflective of evolving investor intentions. The real-time data processing system may comprise an event-based triggering subsystem that may initiate profile recalibration upon detection of significant corporate events, such as leadership changes, controversies, or the publication of updated sustainability reports. The real-time data processing system may further comprise a new data analysis subsystem that may allow the system to re-evaluate previously unclassified proxy agenda items in light of novel disclosures or insights. The real-time data processing system may also comprise a scheduled re-analysis subsystem to perform periodic revalidation of the voter profile, ensuring alignment with changes in regulatory guidance, fund mandates, or investor behavior over time. The system may additionally implement a real-time ingestion mechanism that monitors and incorporates new data points from live data feeds, including regulatory filings, ESG disclosures, and sentiment indicators. These dynamic profile updates may reinforce the accuracy of downstream decision recommendations generated by the recommendation engine 216.

Additionally, the voter profile generation subsystem 212 may support multi-layered profile abstraction, where institutional clients may define a base profile applicable across funds, while overlaying fund-specific rules, such as fossil divestment policies or enhanced disclosure preferences. This may allow for scalable and compliant customization in large portfolios.

The profile output generated by the voter profile generation subsystem 212 may be a structured vector representation that maps the investor's priorities against a standardized proxy taxonomy. This vector may be subsequently ingested by the recommendation engine 216 to generate vote recommendations based on alignment scores and policy fit.

The proxy rights determination subsystem 214 (i.e., an authorization determination subsystem), in one implementation, may be configured to determine a user authorization (e.g., evaluate proxy voting eligibility and determine the effective voting power) attributable to a given investor account. The proxy rights determination subsystem 214 may assess whether an investor is entitled to vote on a particular shareholder resolution, and may calculate the number of votes such investor is authorized to cast, based on verified holdings data and issuer-specific governance structures.

To accomplish this, the proxy rights determination subsystem 214 interfaces with a plurality of external data sources via secure application programming interfaces (APIs), including but not limited to custodial banks, brokerage platforms, transfer agents, clearinghouses, and institutional fund administrators. The retrieved data may include up-to-date beneficial ownership reports, position statements, trade settlement records, and share class breakdowns across asset types such as publicly listed equities, exchange-traded funds (ETFs), mutual funds, and separately managed accounts.

Upon retrieval of shareholding data, the proxy rights determination subsystem 214 may perform alignment of position records with official proxy record dates, as disclosed by issuers or intermediaries. Such time alignment may result in accurate determination of shareholding entitlements at the snapshot date specified by the proxy solicitation process.

In order to determine eligibility beyond simple ownership, the proxy rights determination subsystem 214 may parse the language contained in proxy materials, such as DEF 14A filings or company charter documents, to extract provisions related to voting rights. For instance, the subsystem may identify modifiers such as dual-class share structures, super-voting shares, restricted or non-voting shares, and foreign ownership limits. In one implementation, the subsystem may leverage a Large Language Model (LLM) to analyze a second dataset acquired from a second set of data sources comprising a decision-making prompt (e.g., proxy statements), thereby processing unstructured text and extracting legally significant clauses that may affect an investor's ability to vote. This may include parsing references to “Class A” versus “Class B” shares, statements regarding voting caps, tiered rights under shareholder agreements, and cumulative versus non-cumulative voting mechanics.

Furthermore, the proxy rights determination subsystem 214 may evaluate custodial status of securities to determine whether securities are held directly or through intermediated ownership (e.g., omnibus accounts). In such configurations, the subsystem may execute beneficial owner look-through logic in collaboration with custodians, ensuring that indirect holdings are reconciled with appropriate shareholder entitlements.

In some embodiments, the proxy rights determination subsystem 214 may also process record-keeping exceptions, such as fractional holdings, unsettled trades, securities on loan, or securities under embargo. By incorporating such exception rules, the subsystem may prevent the generation of vote instructions where eligibility is ambiguous or restricted.

The subsystem may output a structured entitlement matrix that maps each shareholder to issuers for which they hold vote-eligible shares, along with calculated vote weights, share classes, record dates, and any applicable restrictions. This matrix may be used downstream by the recommendation engine 216 and the automated voting execution subsystem 218 to generate and transmit accurate vote instructions.

The recommendation engine 216 (i.e., a recommendation system) may be configured to generate predictive, value-aligned decision recommendations (e.g., proxy voting recommendations) by applying advanced natural language processing (NLP), machine learning (ML), and reinforcement learning (RL) techniques. The objective of the recommendation engine 216 may be to generate a decision recommendation interdependently based on the value-aligned user profile and the determined user authorization, wherein the recommendation may comprise a quantitative score corresponding to alignment with the user preferences. In the context of proxy voting, the recommendation engine 216 may analyze parsed proxy content, map it to investor-specific value profiles, and generate vote recommendations for each agenda item with accompanying alignment scores and rationales.

In some embodiments, the recommendation engine 216, as a recommendation system, may comprise one or more large language models (LLMs) and pre-trained transformer-based encoders with multi-head attention mechanisms. The LLMs may be fine-tuned on a diverse corpus of financial documents including annual proxy statements, Form DEF 14A filings, board resolutions, ESG policy literature, historical shareholder vote records, and annotated investor feedback. The LLMs may be trained to identify thematic patterns and policy implications embedded within proxy proposals. The pre-trained transformer-based encoders with multi-head attention mechanisms may model semantic and contextual dependencies between proxy statements and user-aligned value constructs.

The recommendation engine 216 may receive structured and unstructured input from the data processing subsystem 210 and voter profile generation subsystem 212. Upon ingestion of a parsed proxy agenda, the engine may encode each resolution and its accompanying disclosures using transformer-based language embeddings. Simultaneously, the investor's preference vector, generated by the voter profile generation subsystem 212, may be embedded into a latent feature space representing policy alignment vectors (e.g., “pro-environment,” “anti-carbon,” “pro-labor union”).

The recommendation engine 216 may then perform contextual alignment between the encoded agenda item and the preference vector using cosine similarity, KL divergence scoring, or BERT-based semantic ranking models. Each agenda item may be mapped to the closest matching historical analogs, and a probabilistic vote prediction may be generated. The recommendation engine 216 may compute an alignment score, indicating the degree of congruence between the proxy proposal and the voter's expressed values.

In one embodiment, the recommendation engine 216 may use a reinforcement learning with human feedback (RLHF) framework to improve prediction accuracy. The recommendation engine 216 may receive feedback based on post-vote user corrections, execution confirmations, or external outcomes (e.g., changes in ESG scores or investor returns). The system may update the recommendation system based on the recorded decision and whether the decision recommendation was followed. In some embodiments, updating the recommendation system may comprise adjusting a quantitative weight of the recommendation system. Policy gradients and reward functions may be adapted to reduce misalignment across successive voting cycles. The feedback may be stored in a training buffer for online model refinement.

The recommendation engine 216 may further include an explainability subsystem configured to generate an explanation via an explainable AI (XAI) interface to provide rationales behind the decision recommendation. For example, in the case of a vote on executive compensation tied to carbon targets, the rationale may cite “Board's ESG performance tied to CDP Scope 1-2 reductions aligned with investor's low-carbon policy preference.” In other cases, where ambiguity is detected—such as conflicting policy disclosures or absence of prior analogs—the engine may trigger a flag for manual review, tagging the item with low-confidence metadata and historical divergence markers.

In some embodiments, the recommendation engine 216 may support investor-tier customization, allowing retail versus institutional users to apply different decision thresholds, sector-specific rules, or override conditions. Additionally, the engine may dynamically adjust the decision recommendation score based on real-time external data inputs relevant to the predefined value framework. Geographic data may be incorporated to dynamically adjust the decision recommendation based on regional differences in environmental or regulatory conditions. The engine may further dynamically adjust a weight of the predefined value framework based on user-defined rules responsive to external market conditions and sentiment analysis of real-time news and social media data. In some embodiments, the system may apply personalized ethical constraints that override the decision recommendation under user-specified criteria, wherein the value-aligned user profile may integrate established personal values assessments. These inputs may be derived from datasets such as Refinitiv ESG, Glassdoor sentiment metrics, or financial news platforms.

In some embodiments, the recommendation engine 216 may support cohort-level analysis. The system may record decisions made by a cohort of users in response to respective decision-making prompts and whether corresponding decision recommendations were followed. The system may further update the hybrid model based on aggregate trends identified across the recorded decisions of the cohort of users. Additionally, the system may update the recommendation system used to generate the decision recommendation based on aggregated trends identified across the recorded decisions of the cohort of users. For instance, in the context of proxy voting, the system may analyze voting patterns across a plurality of shareholders to identify emerging consensus positions or divergence trends, and may recalibrate recommendation models accordingly.

Referring to FIG. 2, an automated voting execution subsystem 218 (i.e., an automated decision execution subsystem) may be provided as a functional component of the automated proxy voting system 202, the objective of which may be to execute a decision (e.g., facilitate the transmission of structured proxy vote instructions), via electronic integration with a platform (e.g., one or more downstream proxy voting platforms), in accordance with the decision recommendation generated by the recommendation engine 216 and the verified user authorization (e.g., voting entitlements) determined by the proxy rights determination subsystem 214.

In certain embodiments, the automated voting execution subsystem 218 may be configured to generate vote instructions comprising security identifiers such as Committee on Uniform Securities Identification Procedures (CUSIP) numbers, issuer tickers, meeting identifiers, and agenda-level resolution codes. The instructions may be formatted in accordance with the schema requirements of external platforms including, but not limited to, Broadridge ProxyEdge®, Institutional Shareholder Services (ISS) ProxyExchange™, and Equiniti Vote. In one example implementation, the automated voting execution subsystem 218 may construct vote payloads using JSON or XML representations, as prescribed by the Broadridge DirectVote™ API specifications, and may transmit said payloads over secured RESTful interfaces.

Upon transmission of vote instructions, the automated voting execution subsystem 218 may be further configured to receive, parse, and log confirmation responses issued by the respective voting platforms. Such confirmations may include metadata such as timestamped acknowledgments, vote receipt identifiers, status codes indicating successful or failed transmission, and mapping to specific meeting and agenda items. The confirmation data may be stored within the memory 204, enabling generation of a persistent audit trail for regulatory review and investor transparency.

In further embodiments, the automated voting execution subsystem 218 may comprise a real-time monitoring subsystem configured to track execution lifecycle events associated with submitted votes. The subsystem may categorize votes as pending, acknowledged, or failed, and may present status visualizations via the user interface 208. The user interface 208 may further provide options for manual override, escalation workflows, or re-submission of failed instructions.

The automated voting execution subsystem 218 may also implement error handling protocols, including automated retries, schema correction logic, and alternate submission pathways. For instance, in the event of submission failure due to network interruption or malformed payloads, the subsystem may delay transmission and reattempt submission after applying corrective formatting or initiating fallback transport mechanisms such as secure file transfer protocol (SFTP).

In embodiments configured for institutional-scale voting operations, the automated voting execution subsystem 218 may be capable of batching vote instructions across multiple securities and proxy meetings. Batched submissions may be generated in coordination with portfolio-level data retrieved by the proxy rights determination subsystem 214, allowing efficient processing of hundreds or thousands of agenda items in a single execution cycle.

An automated voting execution subsystem 218 may be configured to submit vote instructions to downstream proxy voting platforms. It may use structured identifiers such as CUSIP numbers, meeting IDs, and issuer tickers to assemble instructions, which may be submitted via integration with APIs offered by third-party platforms such as Broadridge, ISS ProxyExchange, or Equiniti. The subsystem may track status responses, log vote acknowledgments, and store time-stamped transaction receipts in the memory 204.

The system 202 may be further configured to access a second set of data sources 226 comprising external public datasets, advocacy group publications, academic indices, and non-profit scorecards. For instance, it may retrieve board diversity metrics from Equilar, executive compensation reports from Morningstar, or anti-union scoring from National Right to Work Legal Defense Foundation data.

In an exemplary operational workflow, the system may receive proxy documents via the data processing subsystem 210, which may parse and store the resolution text and metadata. The voter profile generation subsystem 212 may retrieve the investor's value definitions and generate a profile expressing preferences as voting stances. The proxy rights determination subsystem 214 may confirm vote eligibility based on shareholding position snapshots. The recommendation engine 216 may analyze the parsed agenda using trained LLMs and generate vote predictions, confidence scores, and rationale text. The voting execution subsystem 218 may transmit the vote to the designated intermediary, and the user interface 208 may display the final receipt, status, and audit log to the end user.

In additional embodiments, the system may employ scheduling logic to preemptively scan public filings for newly announced meetings and create workflow queues for upcoming deadlines. Metaheuristic algorithms may be used to optimize decision logic when profiles contain conflicting signals. In yet another embodiment, the system may support collaborative voting environments where proxy preferences may be jointly authored by multiple stakeholders under a shared governance model.

Accordingly, the system 202 may provide an end-to-end solution for automating proxy voting based on personalized value profiles, AI-driven agenda interpretation, regulatory-compliant execution, and transparent confirmation workflows.

### Workflow

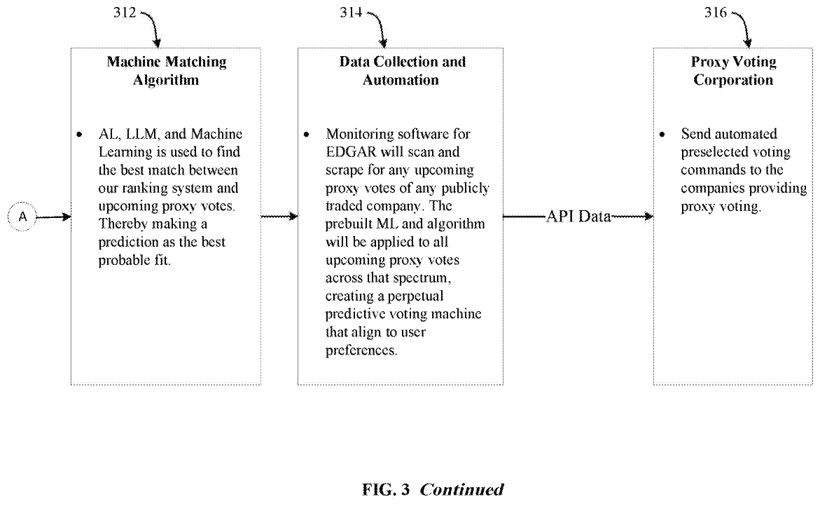

FIG. 3 illustrates an exemplary workflow depicting a process of preference-aligned predictive decision-making (e.g., proxy voting), configured to dynamically generate, match, and execute decision recommendations (e.g., proxy voting decisions) using data-driven machine learning algorithms in accordance with predefined value frameworks.

As shown in FIG. 3, the system architecture 300 may comprise a plurality of investment vehicles 302 holding positions in publicly traded companies. The investment vehicles 302 may include, for example, hedge funds, mutual funds, exchange-traded funds (ETFs), index funds, direct indexing structures, separately managed accounts (SMAs), and individual holdings. These investment vehicles 302 may represent the underlying asset pools whose associated shareholder rights are to be exercised via proxy voting.

The system may aggregate constituent holding data within grouped vehicles 304, including but not limited to fund administrators, custodians, and index creators. The aggregated holding data may be used to associate shareholder voting power with specific investors based on verified ownership records, thereby enabling proxy eligibility determination on an issuer-specific basis.

A collection of client-defined preferences 306 (i.e., user preference data) may be utilized to construct a value-aligned user profile (e.g., a client preference profile), where preferences may be mapped to share accounts across prebuilt value-alignment frameworks constituting a predefined value framework. Such frameworks may include predefined stances such as pro-environmental, pro-labor, pro-union, anti-carbon, diversity-forward, or ESG-compliant strategies. The system may link these preference structures with associated accounts through secure matching protocols, forming the basis of a value-aligned voting model.

A machine learning and data collection subsystem 308 may perform automated extraction and synthesis of training data, employing both traditional machine learning algorithms and large language models (LLMs). The data collected may include historical voting patterns, public market data, M&A signals, news sentiment, corporate announcements, podcasts, and real-time social media analytics. This data may be curated into training corpora for generating proxy vote predictions based on contextual and historical correlation to investor preferences.

The system architecture 300 may include an application programming interface (API) data layer 310 that receives external data feeds from third-party sources, including but not limited to Institutional Shareholder Services (ISS), Broadridge, EDGAR, Glass Lewis, news aggregators, and sustainability databases. This layer may provide up-to-date data ingestion for proxy event detection and agenda item parsing.

A machine matching algorithm 312, executed by the automated proxy voting system, may apply alignment logic to compare the system-generated ranking of proxy items with incoming proxy statements. The algorithm may employ AI-based inferencing, LLM-powered embeddings, and supervised ranking models to determine optimal matches between the investor's stated preferences and the proxy agenda items. In doing so, the algorithm may generate a voting recommendation that is most likely to align with the voter's value framework.

A data collection and automation subsystem 314 may be configured to perform continuous monitoring and scraping of regulatory repositories, such as the EDGAR database, to identify upcoming proxy events. Upon detection, the subsystem may apply the prebuilt machine learning and ranking algorithms to each detected proxy vote, automatically generating vote recommendations aligned with investor preferences. This subsystem may thereby establish a perpetual, self-updating proxy decision engine capable of real-time execution.

Finally, a proxy voting corporation subsystem 316 may be configured to transmit the generated proxy voting instructions to the appropriate corporate entities or voting platforms. The subsystem may use structured identifiers, such as CUSIP numbers and issuer codes, to dispatch electronically signed vote instructions through standardized APIs. The subsystem may interface with platforms such as ISS Proxy Exchange, Broadridge, and Equiniti, and may employ cryptographic ledgers for vote validation and audit logging.

### Graphical User Interface

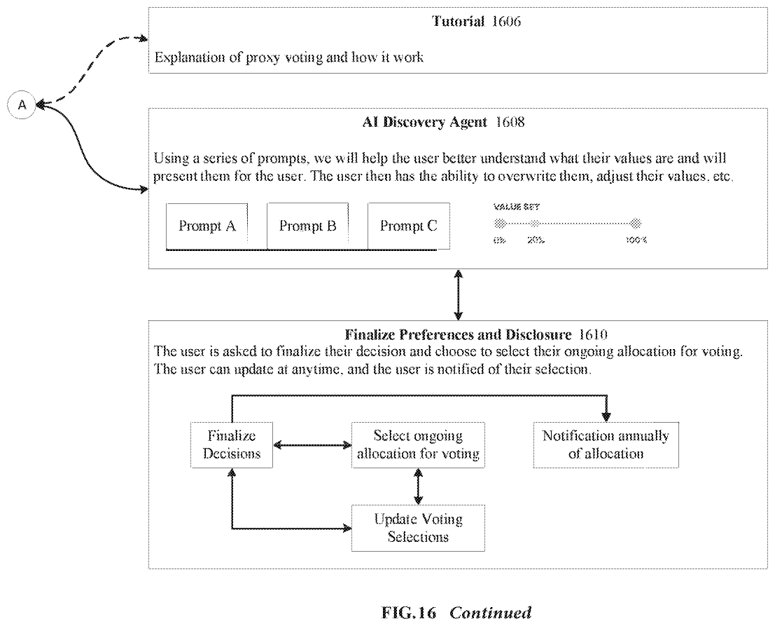

FIG. 16 illustrates an exemplary graphical user interface (GUI) workflow architecture for the automated proxy voting system configured to facilitate onboarding, preference discovery, and automated configuration of value-aligned proxy voting behavior. The GUI may be designed to enable a seamless and interactive user experience by integrating modular components that are logically and functionally interconnected, thereby supporting the complete lifecycle of preference-based voting automation.

The graphical user interface, alternatively referred to as GUI or an interface, may include a customer opt-in subsystem 1602 configured to render disclosure documents, regulatory notices, and terms of service associated with participation in the automated proxy voting system. The customer opt-in subsystem 1602 may be the initial interface presented to the user and may serve as the legal and procedural gateway to system participation. The customer opt-in subsystem 1602 may include interactive digital acknowledgment elements that accept a binary user response (agree/disagree) and trigger the initialization of downstream subsystems upon acceptance.

Upon successful opt-in, control may be transferred to the client preference frameworks subsystem 1604. The client preference frameworks subsystem 1604 may present a list of prebuilt value-alignment frameworks, each rendered with a descriptive title, framework definition, and an associated graphical slider element. The sliders may be configured to accept continuous numeric input in the range of 0% to 100%, allowing users to allocate relative voting weight to each selected framework. The client preference frameworks subsystem 1604 may enforce a cumulative total constraint such that the sum of all weights equals 100%. Such normalized allocation may directly inform the quantitative basis on which subsequent proxy voting recommendations may be generated.

Each slider element within the client preference frameworks subsystem 1604 may be implemented as a live input object that continuously transmits updated values to an internal preference state model stored in the user session layer. For example, a voter may allocate 60% to a “Union Values” framework, 20% to “Long-Term Asset Performance,” and 20% to “Short-Term Performance.” Such configuration may be visually supported by a dynamic information panel illustrating example use cases, such as a Union Pension Fund distributing its voting strategy across multiple objectives. These inputs may be transmitted in real time to the preference configuration backend, where they may be retained as part of the voter profile.

The tutorial subsystem 1606 may be functionally interlinked with the client preference frameworks subsystem 1604 and may be invoked either automatically or upon user request. The tutorial subsystem 1606 may present educational content in the form of guided walkthroughs, definitions, and contextual tooltips designed to ensure comprehension of proxy voting concepts and system functionality. The tutorial subsystem 1606 may be presented through a segmented user flow that utilizes page transitions, progress indicators, and contextual overlays to provide an interactive, informative experience. Integration with the client preference frameworks subsystem 1604 may be performed so that users can reference definitions or access guidance while making real-time adjustments to their value allocations.

Following completion of the initial preference input, the system may transition to the artificial intelligence discovery subsystem 1608. The artificial intelligence discovery subsystem 1608 may interface with the user through a series of structured natural language prompts designed to elicit deeper ethical and strategic voting intentions. The prompts may pertain to topics such as climate policy, executive compensation, labor rights, or corporate transparency. Responses may be processed using machine learning models, including large language models (LLMs), to infer additional preference weightings. These inferred weights may be visually rendered within the GUI alongside the previously entered values, with control elements enabling the user to accept, reject, or modify the system-generated recommendations.

In one aspect, the artificial intelligence discovery subsystem 1608 may include an interactive summary interface that visually displays each selected value framework and its corresponding allocation. The interface may comprise a slider element bounded between 0% and 100% for each value framework. The slider may reflect the percentage weight applied to the respective framework. In the example illustrated in FIG. 16, the allocation displayed under the label “VALUE SET” may be set to 20%. The artificial intelligence discovery subsystem 1608 may maintain full interoperability with the client preference frameworks subsystem 1604, such that updates from AI inference or manual edits may be synchronized across the GUI.

Once preferences are finalized, the user interface may advance to the finalization subsystem 1610. The finalization subsystem 1610 may be configured to receive the voter's preference allocations and confirm their application to ongoing proxy voting operations. The finalization subsystem 1610 may be operatively coupled to the client preference frameworks subsystem 1604 and the artificial intelligence discovery subsystem 1608. Configured preference weights generated by the client preference frameworks subsystem 1604, as well as any machine-inferred or user-adjusted preferences rendered through the artificial intelligence discovery subsystem 1608, may be programmatically transmitted to the finalization subsystem 1610 for consolidation and confirmation.

The finalization subsystem 1610 may present an interactive summary interface that visually displays each selected value framework and its corresponding allocation. The finalization subsystem 1610 may include a configuration mechanism for updating one or more voting selections. Upon invocation of the update functionality, the interface may accept revised input values and reflect the modifications in the allocation summary. Following completion of this input step, the finalization subsystem 1610 may enable the user for selecting an ongoing allocation setting. Upon confirmation, the allocation weights may be finalized and persisted to memory as the operative voter preference model. Subsequent proxy voting decisions may be generated and executed in accordance with the finalized allocation unless explicitly reconfigured by the voter.

Following finalization, the finalization subsystem 1610 may trigger an automated scheduling process configured to issue a periodic notification to the voter. The notification may be generated on an annual basis, measured from the date of the most recent allocation confirmation. The notification may include a prompt to review, reaffirm, or update the existing preference settings. The objective of the process may be to ensure continuous alignment between the automated voting behavior of the system and the current values of the voter. The notification mechanism may be integrated with the user profile and tracked for compliance auditing.

The finalization subsystem 1610 may further support re-entry into the onboarding workflow. The system may be configured to maintain bidirectional integration between the finalization subsystem 1610, the client preference frameworks subsystem 1604, and the artificial intelligence discovery subsystem 1608. Any revised inputs made through the upstream subsystems may be immediately accessible from within the finalization interface. The interface may dynamically update to reflect any modifications in real-time, thereby preserving consistency and enabling immediate reconfirmation of the revised preference distribution.

Throughout the interface, the subsystems, including customer opt-in subsystem 1602, client preference frameworks subsystem 1604, tutorial subsystem 1606, artificial intelligence discovery subsystem 1608, and finalization subsystem 1610, may be interconnected via a modular GUI flow, where each subsystem may transition linearly but allow backward navigation and real-time data persistence. Changes made in one subsystem (e.g., slider adjustment or prompt response) may be immediately reflected across all relevant subsystems to maintain consistency. Input validation and constraint enforcement may be handled at the interface level to ensure regulatory compliance and user intent integrity.

The graphical user interface may employ an array of intuitive control elements, including sliders, buttons, modals, radio selections, and dynamically updated summaries, all of which may be designed to support transparency, interactivity, and informed user participation. The modular design of the GUI may allow for scalable deployment across a range of investor types, including individual retail investors and institutional entities, while maintaining alignment between expressed preferences and proxy voting behavior across the automated system.

### Methods

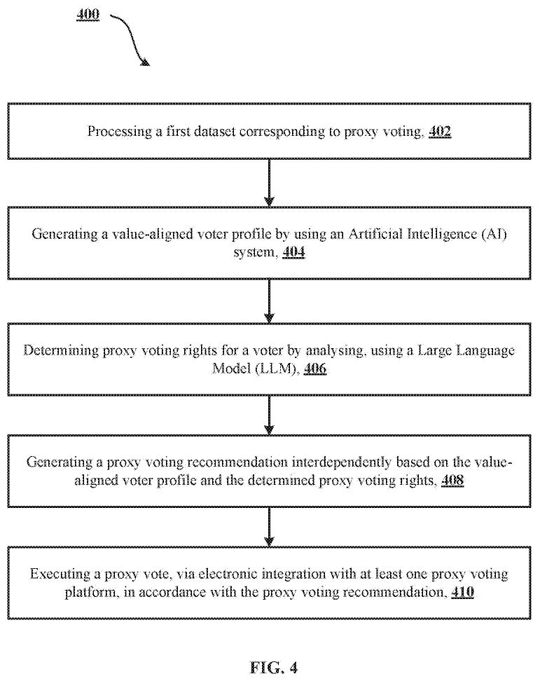

Also FIG. 4 illustrates a flowchart depicting an exemplary method 400 for automatically generating and executing proxy votes in alignment with a predefined voter value framework, in accordance with certain embodiments of the present disclosure.

Step 402 includes receiving a proxy agenda from one or more data sources, such as the U.S. Securities and Exchange Commission's EDGAR database, issuer websites, publicly filed DEF 14A statements, and third-party data feeds including Institutional Shareholder Services (ISS), Glass Lewis, and Broadridge. The proxy agenda may comprise structured and unstructured data elements including resolution texts, meeting notices, director nominations, executive compensation items, shareholder proposals, and procedural matters. This data may be ingested using document parsers, real-time APIs, or custom web crawlers, and parsed using natural language processing models to extract agenda-level metadata into a structured format for downstream processing.

Step 404 includes generating a value-aligned voter profile 404A based on a combination of user-defined voting preferences, historical voting behavior, investor typologies, and regulatory objectives. The voter profile generation subsystem may apply a hybrid inference architecture that includes rule-based classifiers, unsupervised clustering algorithms, and few-shot classification models. The subsystem may reference an internal taxonomy of investor value orientations, such as “pro-environment,” “pro-labor,” “anti-carbon,” or “governance-focused,” and map those preferences to a structured profile vector. The system may enable dynamic recalibration of voter preferences via feedback loops, manual corrections, or behaviorally inferred updates derived from post-vote engagement patterns.

Step 406 includes determining proxy voting rights 406A based on verified beneficial ownership data retrieved via secure integrations with custodians, brokerage firms, and clearinghouses. The proxy rights determination subsystem may parse shareholder position records across equities, ETFs, mutual funds, and separately managed accounts. In some implementations, the subsystem may leverage an LLM interpreter to identify eligibility-impacting language in proxy materials, including dual-class share structures, super-voting rights, or restricted securities. Shareholding snapshots may be aligned to proxy record dates, enabling accurate computation of vote entitlements on a per-agenda basis.

Step 408 includes generating a proxy voting recommendation 408A based on both the value-aligned voter profile and the determined proxy rights. The recommendation may be produced by a recommendation engine comprising one or more fine-tuned large language models trained on regulatory filings, corporate disclosures, annotated vote records, and ESG datasets. The recommendation engine may perform contextual alignment by matching parsed proxy agenda items with the voter's encoded preference vectors. The output may comprise a recommended voting decision for each agenda item, accompanied by a confidence score, an explanatory rationale, and a classification label indicating the degree of alignment. In some embodiments, the recommendation engine may employ reinforcement learning with human feedback to iteratively adapt recommendation strategies. Attention-based transformers may be utilized to prioritize agenda topics exhibiting higher materiality with respect to voter-defined values. Explainable AI (XAI) components may further be implemented to provide transparency into the underlying rationale for each predicted vote.

Step 410 includes submitting the proxy vote 410A to an external proxy execution platform, such as Broadridge, ISS ProxyExchange, or Equiniti, using an application programming interface (API)-driven integration. The vote submission may include structured identifiers such as CUSIP numbers, issuer codes, meeting IDs, and account metadata. The automated voting execution subsystem may log the transaction status, receive confirmation receipts from the third-party platform, and store time-stamped acknowledgments in the system memory.

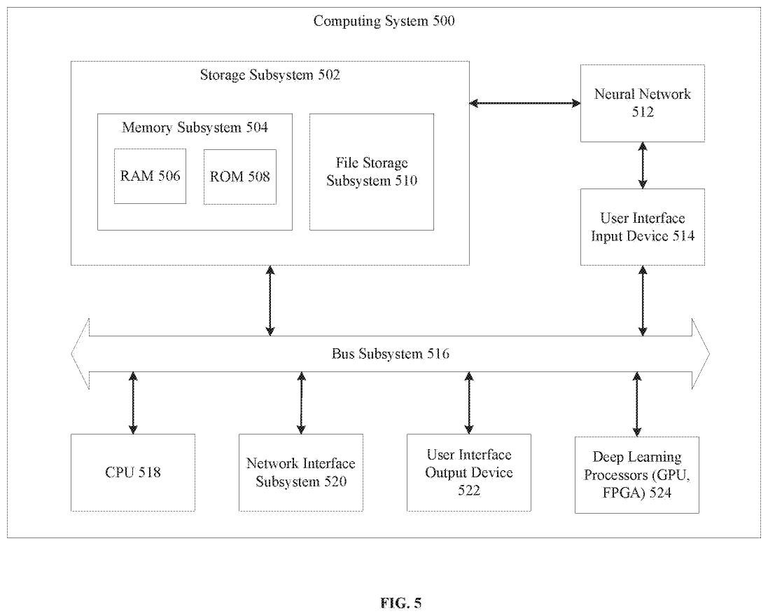

FIG. 5 shows an example computer system 500 that may be used to implement the technology disclosed. The computer system 500 may be a representation of the automated proxy voting system 202, as described in FIG. 2. The computer system 500 may include at least one central processing unit (CPU) 518 that communicates with a number of peripheral devices via bus subsystem 516. These peripheral devices may include a storage subsystem 502 including, for example, memory devices and a file storage subsystem 510, user interface input devices 514, user interface output devices 522, and a network interface subsystem 520. The input and output devices may allow user interaction with computer system 500. Network interface subsystem 520 may provide an interface to outside networks, including an interface to corresponding interface devices in other computer systems.

In one implementation, a neural network 512 may be communicably linked to the storage subsystem 502 and the user interface input devices 514.

User interface input devices 514 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 500.

User interface output devices 522 may include a display subsystem, a printer, a fax machine, or non-visual displays such as audio output devices. The display subsystem may include an LED display, a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include all possible types of devices and ways to output information from computer system 500 to the user or to another machine or computer system.

Storage subsystem 502 may store programming and data constructs that provide the functionality of some or all of the subsystems and methods described herein. These software subsystems may be generally executed by deep learning processors 524.

Deep learning processors 524 may include graphics processing units (GPUs), field-programmable gate arrays (FPGAs), application-specific integrated circuits (ASICs), and/or coarse-grained reconfigurable architectures (CGRAs). Processors 524 may be hosted by a deep learning cloud platform such as Google Cloud Platform™, Xilinx™, and Cirrascale™ Examples of processors 524 may include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 504 used in the storage subsystem 502 may include a number of memories including a main random-access memory (RAM) 506 for storage of instructions and data during program execution and a read only memory (ROM) 508 in which fixed instructions may be stored. A file storage subsystem 510 may provide persistent storage for program and data files, and may include a hard disk drive, a floppy disk drive along with associated removable media, a CD-ROM drive, an optical drive, or removable media cartridges. The subsystems implementing the functionality of certain implementations may be stored by file storage subsystem 510 in the storage subsystem 502, or in other machines accessible by the processor.

Bus subsystem 516 may provide a mechanism for letting the various components and subsystems of computer system 500 communicate with each other as intended. Although bus subsystem 516 is shown schematically as a single bus, alternative implementations of the bus subsystem may use multiple buses.

Computer system 500 itself may be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 500 depicted in FIG. 5 is intended only as a specific example for the purpose of illustrating the preferred implementations of the present technology disclosed. Many other configurations of computer system 500 are possible having more or fewer components than the computer system depicted in FIG. 5.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 5, computer system/server in computing node 700 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCie), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

[System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

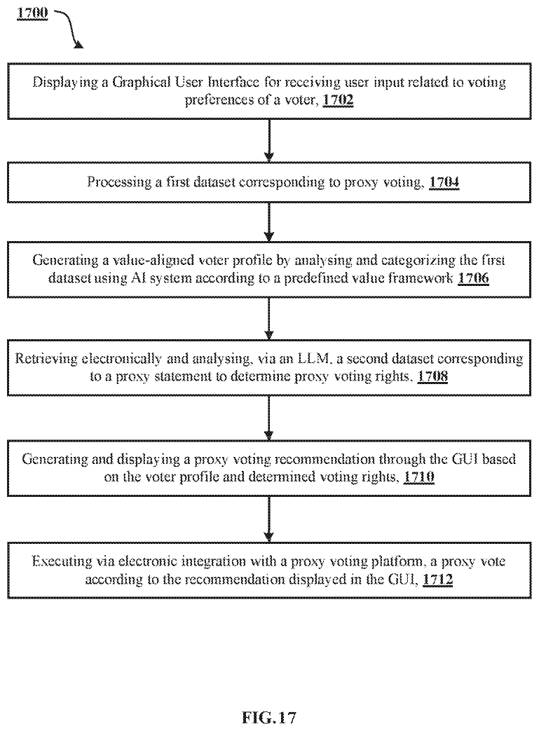

Also described herein are methods using a graphical user interface. FIG. 17 illustrates a flowchart depicting an exemplary method 1700 for automatically generating and executing proxy votes in alignment with a predefined voter value framework using a graphical user interface.

Step 1702 includes displaying, via a display device, a graphical user interface (GUI) configured to receive user input related to voting preferences of a voter. The GUI may comprise graphical elements including sliders, prompts, input fields, and modular interface components rendered to capture structured preference allocations. The user interface may include modules for onboarding, framework weighting, preference discovery, and allocation finalization. Inputs collected through this step may form the basis of a voter-defined preference model and may be retained in memory for downstream analytical processing.

Step 1704 includes processing a first dataset corresponding to proxy voting. The first dataset may be acquired from a first set of data sources and may comprise data related to voter preferences and data related to voting entities. The dataset may include structured inputs received via the GUI, historical proxy voting data, social media expressions, political contribution records, and values-aligned sentiment data derived from natural language sources. The data processing subsystem may apply natural language processing (NLP), feature extraction, and weighting normalization to produce a structured dataset for profile generation.

Step 1706 includes generating a value-aligned voter profile 1706A by analyzing and categorizing the first dataset using an artificial intelligence (AI) system configured in accordance with a predefined value framework. The AI system may employ supervised machine learning models, unsupervised clustering techniques, and rule-based inferencing to identify salient value signals within the first dataset. The predefined value framework may comprise stances such as pro-environmental, pro-union, pro-labor, pro-governance, or long-term performance oriented. The voter profile may comprise a weighted vector representation of the user's ethical and financial priorities, which may be dynamically updated through direct user interaction or inferred behavioral signals.

Step 1708 includes retrieving and analyzing a second dataset corresponding to a proxy statement using a large language model (LLM) to determine proxy voting rights 1708A. The second dataset may be acquired from a second set of data sources including publicly available proxy filings (e.g., SEC EDGAR), company websites, shareholder communications, and data providers such as ISS and Broadridge. The LLM may interpret both structured and unstructured language from these proxy materials to extract voting entitlements, eligibility criteria, and resolution metadata. Proxy rights determination may include mapping beneficial ownership records, reconciling record dates, and identifying share class-based entitlements and voting constraints.

Step 1710 includes generating and displaying a proxy voting recommendation 1710A through the GUI based on the value-aligned voter profile and the determined proxy voting rights. The proxy voting recommendation may be generated by a recommendation engine comprising fine-tuned large language models and context-aware matching algorithms. The engine may align parsed proxy agenda items with voter preferences and may produce a recommendation that includes a decision (e.g., For, Against, Abstain), a confidence score, and a classification label indicating degree of alignment. The GUI may render this recommendation with graphical indicators and, in some embodiments, overlays generated by Explainable AI (XAI) subsystems to provide transparency into the rationale for each recommendation.

Step 1712 includes executing, via electronic integration with a proxy voting platform, a proxy vote according to the recommendation displayed in the GUI. The proxy vote execution may be performed through an application programming interface (API) connected to third-party platforms such as Broadridge, ISS ProxyExchange, or Equiniti. The voting instructions may include identifiers such as CUSIP, meeting ID, and account-level metadata. The system may record the transaction status, timestamps, and confirmation receipts received from the external platform. These artifacts may be stored in persistent memory for compliance verification and audit trail maintenance.

In some embodiments, steps 1702 through 1712 may be performed in a sequential and automated fashion such that a proxy vote may be autonomously generated and submitted without manual intervention after final user confirmation during onboarding. The system may further support dynamic profile updates and real-time integration of external data feeds, ensuring that voting behavior remains aligned with evolving voter-defined frameworks.

### Artificial Intelligence System Implementation

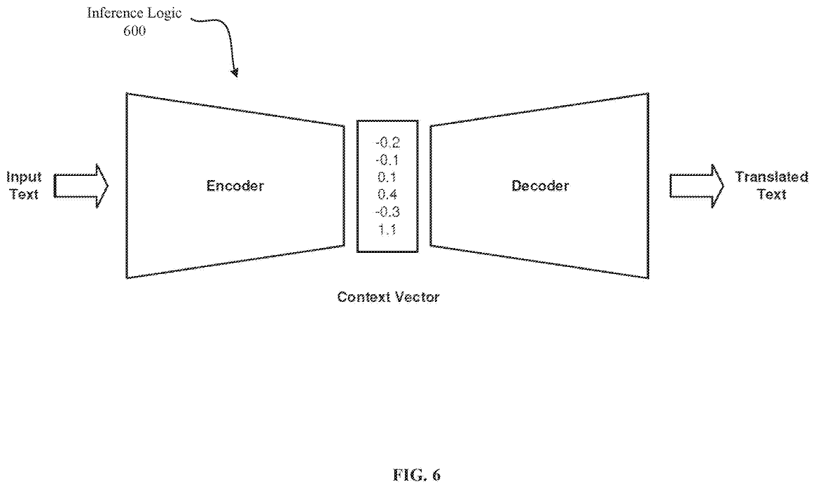

The system described in conjunction with FIG. 2 may comprise one or more subsystems based on Artificial Intelligence. Implementation of the subsystems based on the Artificial Subsystems is illustrated by FIGS. 6 to 16.
Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, TS, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-DI, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use ID convolutions, 2D convolutions, 3D convolutions, 4D convolutions, SD convolutions, dilated or atrous convolutions, transpose convolutions, depthwise separable convolutions, pointwise convolutions, I×I convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, LI loss, L2 loss, smooth LI loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that may learn and adapt without following explicit instructions, by using algorithms and statistical models to analyze and draw inferences from patterns in data. Some of the state-of-the-art models may use Transformers, a more powerful and faster model than neural networks alone. Transformers originate from the field of natural language processing (NLP), but may be used in computer vision and many other fields. Neural networks may process input in series and weight relationships by distance in the series. Transformers may process input in parallel and do not necessarily weigh by distance. For example, in natural language processing, neural networks may process a sentence from beginning to end with the weights of words close to each other being higher than those further apart. This may leave the end of the sentence very disconnected from the beginning causing an effect called the vanishing gradient problem. Transformers may look at each word in parallel and determine weights for the relationships to each of the other words in the sentence. These relationships are called hidden states because they may be later condensed for use into one vector called the context vector. Transformers may be used in addition to neural networks. This architecture is described herein.

### Encoder-Decoder Architecture

FIG. 6 is a schematic representation of an encoder-decoder architecture. This architecture is often used for NLP and has two main building blocks. The first building block is the encoder that encodes an input into a fixed-size vector. In the system described herein, the encoder may be based on a recurrent neural network (RNN). At each time step, t, a hidden state of time step, t−1, may be combined with the input value at time step t to compute the hidden state at timestep t. The hidden state at the last time step, encoded in a context vector, may contain relationships encoded at all previous time steps. For NLP, each step may correspond to a word. Then the context vector may contain information about the grammar and the sentence structure. The context vector may be considered a low-dimensional representation of the entire input space. For NLP, the input space may be a sentence, and a training set may consist of many sentences.

The context vector may then be passed to the second building block, the decoder. For translation, the decoder may have been trained on a second language. Conditioned on the input context vector, the decoder may generate an output sequence. At each time step, t, the decoder may be fed the hidden state of time step, t−1, and the output generated at time step, t−1. The first hidden state in the decoder may be the context vector, generated by the encoder. The context vector may be used by the decoder to perform the translation.

The whole model may be optimized end-to-end by using backpropagation, a method of training a neural network in which the initial system output is compared to the desired output and the system is adjusted until the difference is minimized. In backpropagation, the encoder may be trained to extract the right information from the input sequence, the decoder may be trained to capture the grammar and vocabulary of the output language. This may result in a fluent model that uses context and generalizes well. When training an encoder-decoder model, the real output sequence may be used to train the model to prevent mistakes from stacking. When testing the model, the previously predicted output value may be used to predict the next one.

When performing a translation task using the encoder-decoder architecture, all information about the input sequence may be forced into one vector, the context vector. Information connecting the beginning of the sentence with the end may be lost, the vanishing gradient problem. Also, different parts of the input sequence may be important for different parts of the output sequence, information that may not be learned using only RNNs in an encoder-decoder architecture.

### Attention Mechanism

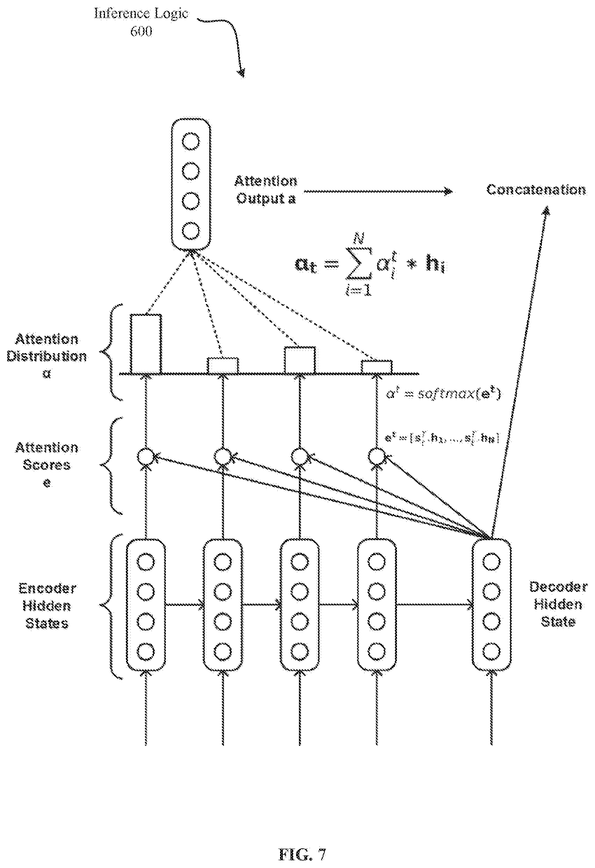

Attention mechanisms distinguish Transformers from other machine learning models. The attention mechanism may provide a solution for the vanishing gradient problem. FIG. 7 shows an overview of an attention mechanism added onto an RNN encoder-decoder architecture. At every step, the decoder may be given an attention score, e, for each encoder hidden state. In other words, the decoder may be given weights for each relationship between words in a sentence. The decoder may use the attention score concatenated with the context vector during decoding. The output of the decoder at time step t may be based on all encoder hidden states and the attention outputs. The attention output may capture the relevant context for time step t from the original sentence. Thus, words at the end of a sentence may have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, may be calculated. This may result in an attention score for every encoder hidden state. The attention scores may be higher for those encoder hidden states that are similar to the decoder hidden state of the current time step. Higher values for the dot product may indicate the vectors are pointing more closely in the same direction. The attention scores may be converted to fractions that sum to one using the SoftMax function.

The SoftMax scores may provide an attention distribution. The x-axis of the distribution may be position in a sentence. The y-axis may be attention weight. The scores may show which encoder hidden states are most closely related. The SoftMax scores may specify which encoder hidden states are the most relevant for the decoder hidden state of the current time step.

The elements of the attention distribution may be used as weights to calculate a weighted sum over the different encoder hidden states. The outcome of the weighted sum is called the attention output. The attention output may be used to predict the output, often in combination (concatenation) with the decoder hidden states. Thus, both information about the inputs, as well as the already generated outputs, may be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model may need to be numerical. The input to a translation model may be a sentence, and words are not numerical. Multiple methods exist for the conversion of words into numerical vectors. These numerical vectors may be referred to as the embeddings of the words. Embeddings may be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use ID convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

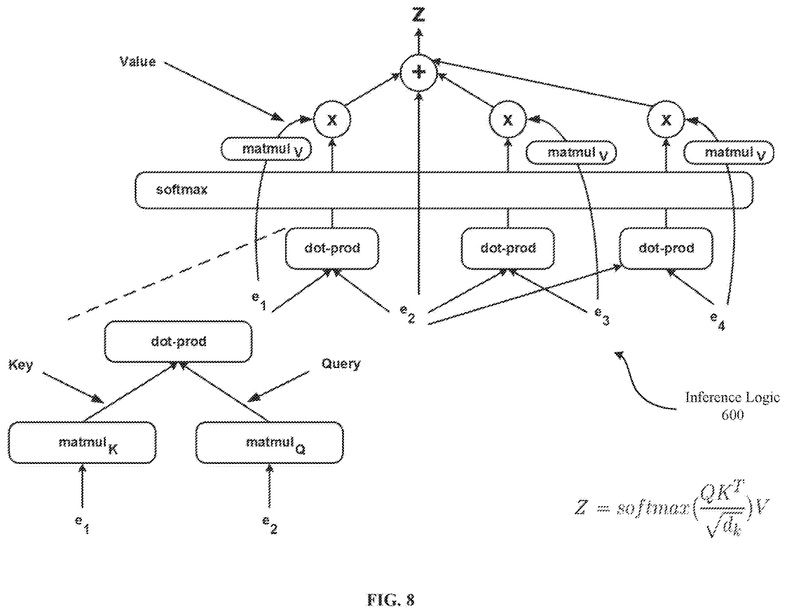

Multi-headed attention is executed in the Transformer. FIG. 8 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix Wis trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. These may be thought of as analogous to databases. There may be a user-defined query of what the user wants to know. Then there are the relations in the database, i.e., the values which are the weights. More advanced database management systems may create some apt representation of its relations to retrieve values more efficiently from the relations. This may be achieved by using indexes, which represent information about what is stored in the database. In the context of attention, indexes may be thought of as keys. So instead of running the query against values directly, the query may first be executed on the indexes to retrieve where the relevant values or weights are stored. Lastly, these weights may be run against the original values to retrieve data that is most relevant to the initial query.

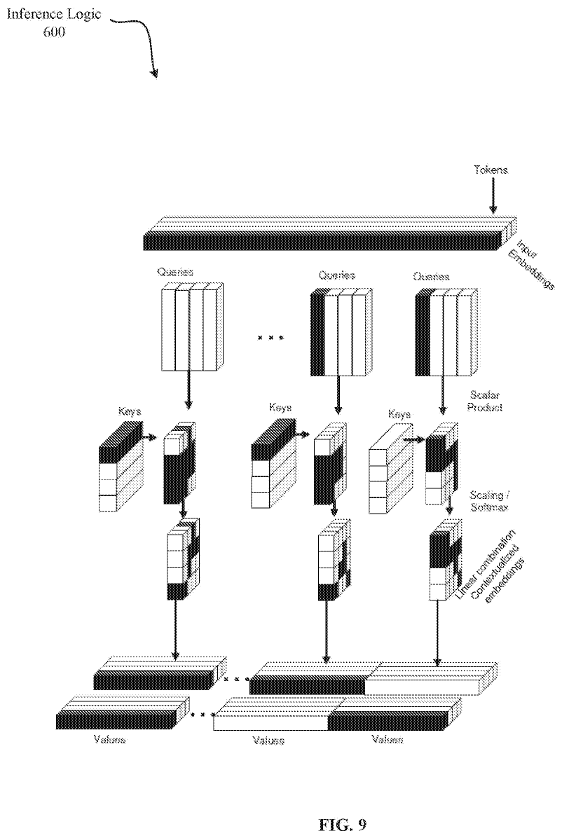

FIG. 9 depicts several attention heads in a Transformer block. It can be observed that the outputs of queries and keys dot products in different attention heads are differently colored. This may depict the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modem hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as −/dk.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = Soft Max ( \frac{{QK}^{T}}{√ ( dk )} ) V$$

where Q, K, V are computed as:

X·W_{Q},X·W_{K},X·W_{V}

X is the input matrix and W_{W}, W_{K}, W_{V} are learned weights to project the input matrix into the representations. The dot products appearing in the attention function may be exploited for their geometrical interpretation where higher values of their results mean that the inputs are more similar, (i.e., pointing in the geometrical space in the same direction). Since the attention function now works with matrices, the dot product becomes matrix multiplication. The SoftMax function may be used to normalize the attention weights into the value of 1 prior to being multiplied by the values matrix. The resulting matrix may be used either as input into another layer of attention or may become the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

MultiHeadAttention(Q,K,V)=[head₁, . . . ,headₕ]W₀

where:

$${head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

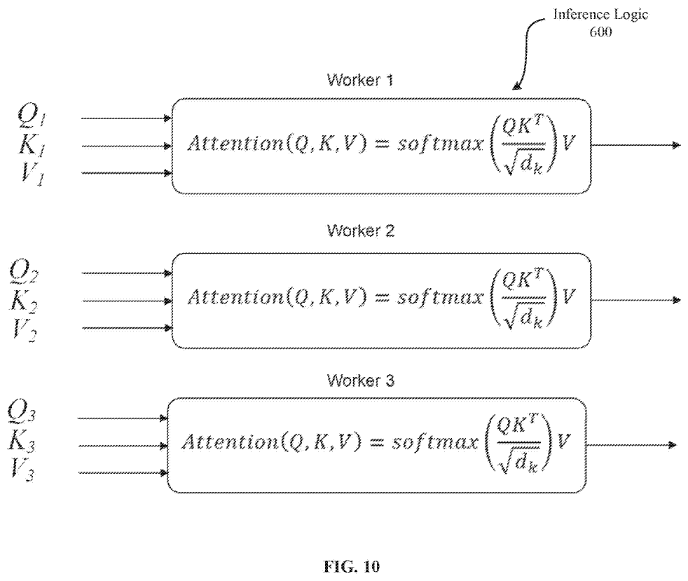

As shown in FIG. 10, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (b, c), to obtain values Q, K, V, it may be necessary to compute the operations:

X·W_{W},X·W_{K},X·W_{V}

The matrix X is of shape (n, d) where n is the number of patches and d is the hidden vector dimension. The weights W_{Q}, W_{K}, W_{V} are all of shape (d, d). Omitting the constant factor 3, the resulting complexity is:

n·d²

Proceeding to the estimation of the complexity of the attention function itself, i.e., of SoftMax( )V. The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$Soft Max ( \frac{{QK}^{T}}{\sqrt{dk}} ) V$$

is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d

The asymptotic complexity of multi-head attention may be the same since the original input matrix X may be projected into h matrices of shapes (n), where h is the number of heads. From the point of view of asymptotic complexity, h is constant, therefore one may arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

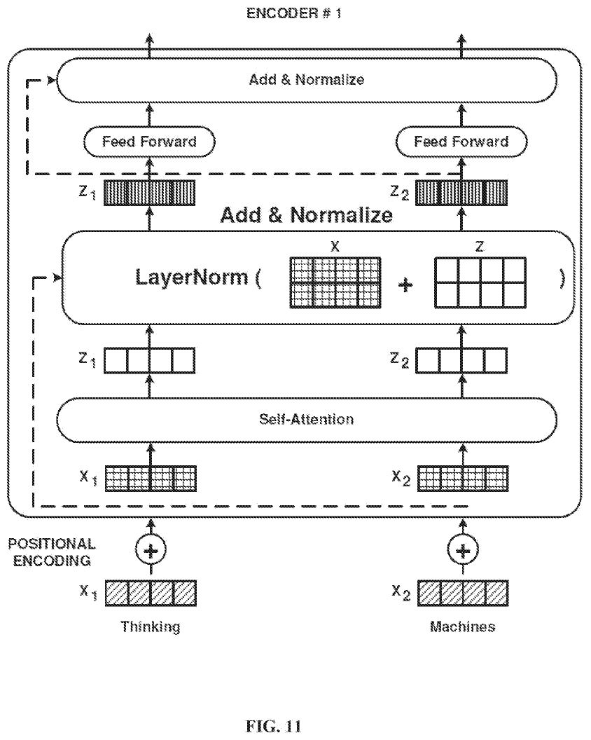

FIG. 11 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

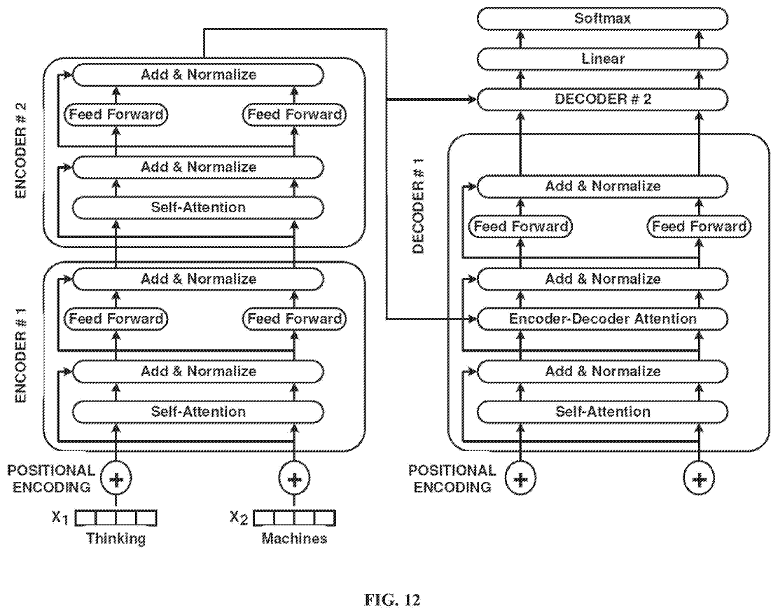

FIG. 12 shows a schematic overview of a Transformer model. Next to a self-attention layer, a layer of encoder-decoder attention may be present in the decoder, in which the decoder may examine the last Z vectors of the encoder, providing fluent information transmission. The ultimate decoder layer may be a feed-forward layer. All layers may be packed in a residual connection. This may allow the decoder to examine all previously predicted outputs and all encoded input vectors to predict the next output. Thus, information from the encoder may be provided to the decoder, which may improve the predictive capacity. The output vectors of the last decoder layer may need to be processed to form the output of the entire system. This may be done by a combination of a feed-forward layer and a SoftMax function. The output corresponding to the highest probability may be the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

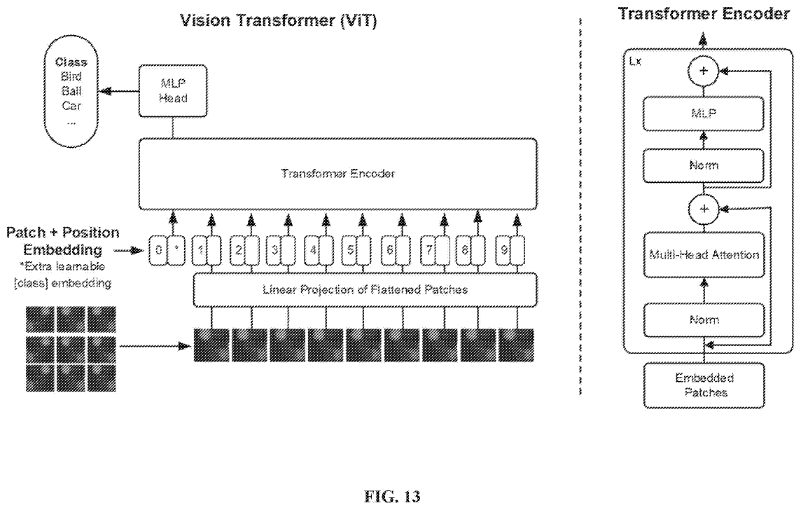

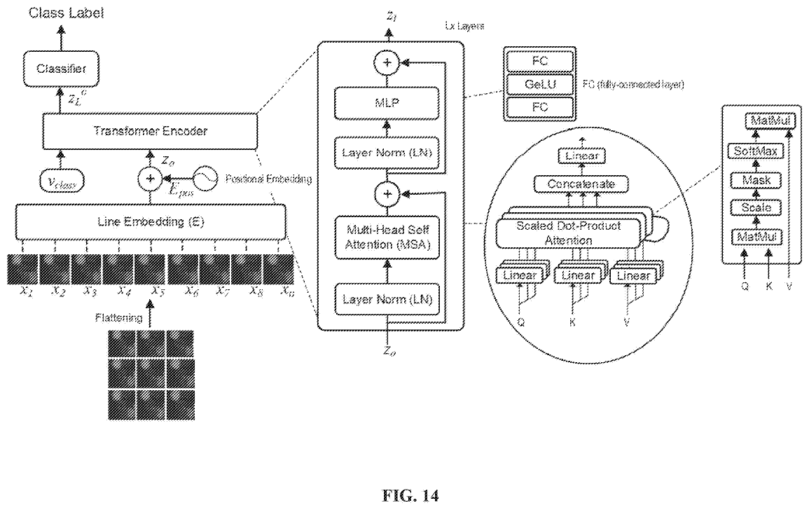

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIGS. 13A, 13B, 14A, 14B, 14C, and 14D. Unfortunately, important positional information is lost because image sets are position-invariant. This problem is solved by adding a learned positional encoding into the image patches.

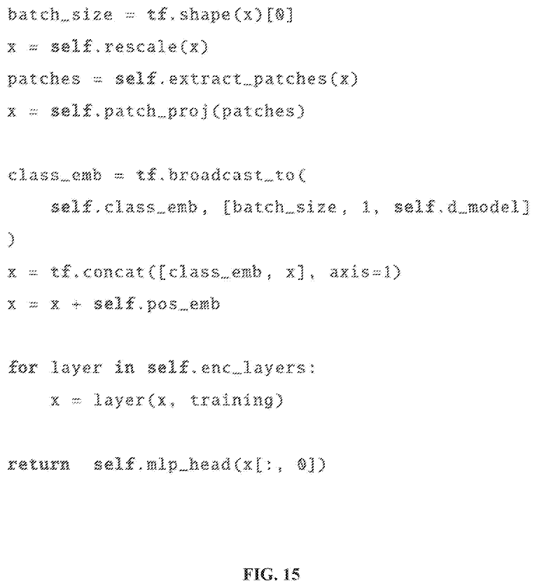

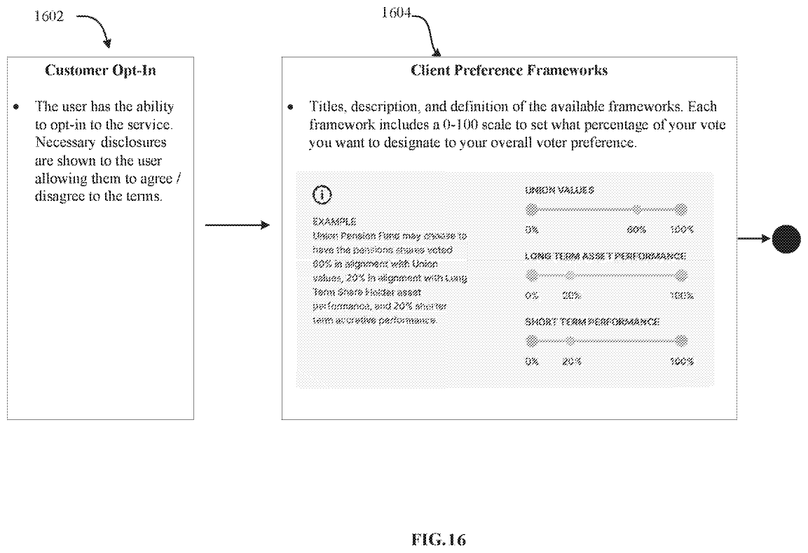

The computations of the ViT architecture may be summarized as follows. The first layer of a ViT may extract a fixed number of patches from an input image (13A). The patches may then be projected to linear embeddings. A special class token vector may be added to the sequence of embedding vectors to include all representative information of all tokens through the multi-layer encoding procedure. The class vector may be unique to each image. Vectors containing positional information may be combined with the embeddings and the class token. The sequence of embedding vectors may be passed into the Transformer blocks. The class token vector may be extracted from the output of the last Transformer block and may be passed into a multilayer perceptron (MLP) head whose output is the final classification. The perceptron may take the normalized input and place the output in categories. It may classify the images. This procedure may directly translate into the Python Kerns code shown in FIG. 15.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block in FIG. 13B, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as subsystems, can be implemented in hardware or software, and need not be divided up in precisely the same blocks as shown in the figures. Some of the subsystems can also be implemented on different processors, computers, or servers, or spread among a number of different processors, computers, or servers. In addition, it will be appreciated that some of the subsystems can be combined, operated in parallel or in a different sequence than that shown in the figures without affecting the functions achieved. The subsystems in the figures can also be thought of as flowchart steps in a method. A subsystem also need not necessarily have all its code disposed contiguously in memory; some parts of the code can be separated from other parts of the code with code from other subsystems or other functions disposed in between.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware subsystem(s), (ii) software subsystem(s) executing on one or more hardware processors, or (iii) a combination of hardware and software subsystems; any of (i)-(iii) implement the specific techniques set forth herein, and the software subsystems are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method for automated authorized decision-making, comprising:
processing a first dataset acquired from a first set of data sources, wherein the first dataset comprises user preference data and non-user entity data;
generating a value-aligned user profile using a hybrid model to analyze the first dataset according to a predefined value framework;
determining a user authorization using a Large Language Model (LLM) to analyze a second dataset acquired from a second set of data sources comprising a decision-making prompt; and
generating a decision recommendation interdependently based on the value-aligned user profile and the determined user authorization, wherein the recommendation comprises a quantitative score corresponding to alignment with the user preferences.

2. The method of claim 1, further comprising executing a decision, via electronic integration with a platform, in accordance with the recommendation.

3. The method of claim 1, wherein the hybrid model comprises one or more of rule-based decision trees, unsupervised learning models, few-shot classification models, or clustering models.

4. The method of claim 1, further comprising recording a decision made by the user in response to the decision-making prompt and whether the decision recommendation was followed.

5. The method of claim 4, further comprising updating the hybrid model based on the recorded decision and whether the decision recommendation was followed.

6. The method of claim 5, wherein updating the hybrid model comprises adjusting a quantitative weight of the hybrid model.

7. The method of claim 4, further comprising updating the user preference data based on the recorded decision and whether the decision recommendation was followed.

8. The method of claim 4, further comprising updating the value-aligned user profile based on the recorded decision and whether the decision recommendation was followed.

9. The method of claim 4, wherein the decision recommendation is generated using a recommendation system.

10. The method of claim 9, wherein the recommendation system comprises a Large Language Model (LLM) and pre-trained transformer-based encoders with multi-head attention mechanisms.

11. The method of claim 9, further comprising updating the recommendation system based on the recorded decision and whether the decision recommendation was followed.

12. The method of claim 11, wherein updating the recommendation system comprises adjusting a quantitative weight of the recommendation system.

13. The method of claim 1, further comprising recording decisions made by a cohort of users in response to respective decision-making prompts and whether corresponding decision recommendations were followed.

14. The method of claim 13, further comprising updating the hybrid model based on aggregate trends identified across the recorded decisions of the cohort of users.

15. (canceled)

16. The method of claim 13, further comprising updating a recommendation system used to generate the decision recommendation based on aggregated trends identified across the recorded decisions of the cohort of users.

17. The method of claim 1, wherein generating the value-aligned user profile comprises categorizing the first dataset in accordance with the predefined value framework using the hybrid model.

18.-22. (canceled)

23. The method of claim 1, wherein generating the decision recommendation comprises:
determining a true impact of a decision by applying causal inference techniques, and performing counterfactual analysis to assess alternative outcomes of the decision; and
forecasting impacts of the decision by performing predictive analytics using a recommendation system, wherein the recommendation system comprises regulations, best practices, and technological data.

24. The method of claim 1, wherein generating the decision recommendation further comprises setting a user-defined confidence threshold that prompts a manual review when the threshold is unmet.

25. The method of claim 1, further comprising continuously updating the value-aligned user profile based on a real-time data processing system comprising an event-based triggering subsystem, a new data analysis subsystem, and a scheduled re-analysis subsystem.

26. (canceled)

27. The method of claim 1, further comprising dynamically adjusting the decision recommendation score based on real-time external data inputs relevant to the predefined value framework.

28.-29. (canceled)

30. The method of claim 1, further comprising applying personalized ethical constraints that override the decision recommendation under user-specified criteria, wherein the value-aligned user profile integrates established personal values assessments.

31. A system for automated authorized decision-making, comprising:
a data processing subsystem configured to process a first dataset acquired from a first set of data sources, wherein the first dataset comprises user preference data and non-user entity data;
a user profile generation subsystem configured to generate a value-aligned user profile using a hybrid model to analyze the first dataset according to a predefined value framework;
an authorization determination subsystem configured to determine a user authorization using a Large Language Model (LLM) to analyze a second dataset acquired from a second set of data sources comprising a decision-making prompt;
a recommendation engine configured to generate a decision recommendation interdependently based on the value-aligned user profile and the determined user authorization, wherein the recommendation comprises a quantitative score corresponding to alignment with the user preferences; and
an automated decision execution subsystem configured to execute a decision, via electronic integration with a platform, in accordance with the decision recommendation.

32. A non-transitory computer-readable medium storing instructions, that when executed by one or more processors, causes the processors to perform operations comprising:
processing a first dataset acquired from a first set of data sources, and wherein the first dataset comprises user preference data and non-user entity data;
generating a value-aligned user profile using a hybrid model to analyze the first dataset according to a predefined value framework;
determining a user authorization using a Large Language Model (LLM) to analyze a second dataset acquired from a second set of data sources comprising a decision-making prompt;
generating a decision recommendation interdependently based on the value-aligned user profile and the determined user authorization, wherein the recommendation comprises a quantitative score corresponding to alignment with the user preferences; and
executing a decision, via electronic integration with a platform, in accordance with the decision recommendation.

33.-45. (canceled)

46. The method of claim 1, further comprising dynamically adjusting the decision recommendation score based on real-time external data inputs relevant to the predefined value framework, and rendering, via an explainable AI (XAI) interface, counterfactual analysis results alongside the adjusted decision recommendation.

47. The method of claim 1, wherein determining the user authorization comprises applying the Large Language Model (LLM) to parse the second dataset comprising at least one of proxy statements, regulatory filings, or meeting notices to extract voting eligibility criteria and applicable share class restrictions.
